(19) United States
(12) Patent Application Publication
(10) Pub. No.: US 2026/0067031 A1
(43) Pub. Date: Mar. 5, 2026

(54) METHODS AND APPARATUS FOR MAPPING TRANSPORT BLOCKS

(71) Applicant: QUALCOMM Incorporated, San Diego, CA (US)

(72) Inventors: Mostafa KHOSHNEVISAN, San Diego, CA (US); Kianoush HOSSEINI, San Diego, CA (US); Jing SUN, San Diego, CA (US)

(21) Appl. No.: 18/822,370

(22) Filed: Sep. 2, 2024

(51) Int. Cl. H04L 1/00; H04L 5/00

(52) U.S. Cl. CPC H04L 1/0071; H04L 5/001

(57) ABSTRACT

Aspects of the present disclosure include methods, apparatuses, and computer readable media for receiving, from a transmitting device, a transport block including one or more code blocks having a plurality of bits configured to be separated into at least a first layer set and a second layer set of a plurality of layer sets in a first subband a plurality of subbands, and a third layer set and a fourth layer set of the plurality of layer sets in a second subband of the plurality of subbands, each layer set of the plurality of layer sets of each subband of the plurality of subbands has a corresponding modulation order and reading the plurality of bits in the one or more code blocks by de-interleaving bits in one or more layer sets of the plurality of layer sets separately or jointly with other layer sets of the plurality of layer sets.

### BACKGROUND

Aspects of the present disclosure relate generally to wireless communications, and more particularly, to apparatuses and methods for mapping transport blocks.

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data; ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired.

In a wireless communication network, flexible spectrum integration may be used to combine multiple component carriers (CC), which may belong to the same or different bands, to form a virtual carrier/cell. This provides increased flexibility when providing uplink and/or downlink communications as multiple carriers may be used for carrying control and/or data signals. However, bits in different component carriers may be encoded differently. As such, the integration into a single virtual carrier may not be a trivial task. Therefore, improvement may be desirable to properly handle multiple CCs in the flexible spectrum integration scheme.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure include methods by a transmitting device including identifying a transport block including a plurality of bits configured to be separated into at least a first layer set and a second layer set of a plurality of layer sets in a first subband a plurality of subbands and a third layer set and a fourth layer set of the plurality of layer sets in a second subband of the plurality of subbands, each layer set having a corresponding modulation order, mapping the plurality of bits into one or more code blocks by interleaving first bits in the first layer set, second bits in the second layer set, third bits in the third layer set, and fourth bits in the fourth layer set separately, first bits in the first layer set with second bits in the second layer set and third bits in the third layer set with fourth bits in the fourth layer set, first bits in the first layer set with third bits in the third layer set and second bits in the second layer set with fourth bits in the fourth layer set, or first bits in the first layer set, second bits in the second layer set, third bits in the third layer set, and fourth bits in the fourth layer set jointly, and transmitting the one or more code blocks to a receiving device.

Other aspects of the present disclosure include a transmitting device having one or more memories comprising instructions, a transceiver, and one or more processors operatively coupled with the one or more memories and the transceiver, the one or more processors being configured to execute instructions in the memory to identify a transport block including a plurality of bits configured to be separated into at least a first layer set and a second layer set of a plurality of layer sets in a first subband a plurality of subbands and a third layer set and a fourth layer set of the plurality of layer sets in a second subband of the plurality of subbands, each layer set having a corresponding modulation order, map the plurality of bits into one or more code blocks by interleaving first bits in the first layer set, second bits in the second layer set, third bits in the third layer set, and fourth bits in the fourth layer set separately, first bits in the first layer set with second bits in the second layer set and third bits in the third layer set with fourth bits in the fourth layer set, first bits in the first layer set with third bits in the third layer set and second bits in the second layer set with fourth bits in the fourth layer set, or first bits in the first layer set, second bits in the second layer set, third bits in the third layer set, and fourth bits in the fourth layer set jointly, and transmit the one or more code blocks to a receiving device.

An aspect of the present disclosure includes a transmitting device including means for identifying a transport block including a plurality of bits configured to be separated into at least a first layer set and a second layer set of a plurality of layer sets in a first subband a plurality of subbands and a third layer set and a fourth layer set of the plurality of layer sets in a second subband of the plurality of subbands, each layer set having a corresponding modulation order, means for mapping the plurality of bits into one or more code blocks by interleaving first bits in the first layer set, second bits in the second layer set, third bits in the third layer set, and fourth bits in the fourth layer set separately, first bits in the first layer set with second bits in the second layer set and third bits in the third layer set with fourth bits in the fourth layer set, first bits in the first layer set with third bits in the third layer set and second bits in the second layer set with fourth bits in the fourth layer set, or first bits in the first layer set, second bits in the second layer set, third bits in the third layer set, and fourth bits in the fourth layer set jointly, and means for transmitting the one or more code blocks to a receiving device.

Some aspects of the present disclosure include non-transitory computer readable media having instructions stored therein that, when executed by one or more processors of a transmitting device, cause the one or more processors to identify a transport block including a plurality of bits configured to be separated into at least a first layer set and a second layer set of a plurality of layer sets in a first subband a plurality of subbands and a third layer set and a fourth layer set of the plurality of layer sets in a second subband of the plurality of subbands, each layer set having a corresponding modulation order, map the plurality of bits into one or more code blocks by interleaving first bits in the first layer set, second bits in the second layer set, third bits in the third layer set, and fourth bits in the fourth layer set separately, first bits in the first layer set with second bits in the second layer set and third bits in the third layer set with fourth bits in the fourth layer set, first bits in the first layer set with third bits in the third layer set and second bits in the second layer set with fourth bits in the fourth layer set, or first bits in the first layer set, second bits in the second layer set, third bits in the third layer set, and fourth bits in the fourth layer set jointly, and transmit the one or more code blocks to a receiving device.

Aspects of the present disclosure includes a method by a receiving device for receiving, from a transmitting device, a transport block including one or more code blocks having a plurality of bits configured to be separated into at least a first layer set and a second layer set of a plurality of layer sets in a first subband a plurality of subbands, and a third layer set and a fourth layer set of the plurality of layer sets in a second subband of the plurality of subbands, each layer set of the plurality of layer sets of each subband of the plurality of subbands has a corresponding modulation order and reading the plurality of bits in the one or more code blocks by de-interleaving first bits in the first layer set, second bits in the second layer set, third bits in the third layer set, and fourth bits in the fourth layer set separately, first interleaved bits based on the transmitter interleaving first bits in the first layer set and second bits in the second layer set and second interleaved bits based on the transmitter interleaving third bits in the third layer set and fourth bits in the fourth layer set, first interleaved bits based on the transmitter interleaving first bits in the first layer set and third bits in the third layer set and second interleaved bits based on the transmitter interleaving second bits in the second layer set and fourth bits in the fourth layer set, or interleaved bits based on the transmitter jointly interleaving first bits in the first layer set, second bits in the second layer set, third bits in the third layer set, and fourth bits in the fourth layer set.

Other aspects of the present disclosure include a transmitting device having one or more memories comprising instructions, a transceiver, and one or more processors operatively coupled with the one or more memories and the transceiver, the one or more processors being configured to execute instructions in the memory to receive, from a transmitting device, a transport block including one or more code blocks having a plurality of bits configured to be separated into at least a first layer set and a second layer set of a plurality of layer sets in a first subband a plurality of subbands, and a third layer set and a fourth layer set of the plurality of layer sets in a second subband of the plurality of subbands, each layer set of the plurality of layer sets of each subband of the plurality of subbands has a corresponding modulation order and read the plurality of bits in the one or more code blocks by de-interleaving first bits in the first layer set, second bits in the second layer set, third bits in the third layer set, and fourth bits in the fourth layer set separately, first interleaved bits based on the transmitter interleaving first bits in the first layer set and second bits in the second layer set and second interleaved bits based on the transmitter interleaving third bits in the third layer set and fourth bits in the fourth layer set, first interleaved bits based on the transmitter interleaving first bits in the first layer set and third bits in the third layer set and second interleaved bits based on the transmitter interleaving second bits in the second layer set and fourth bits in the fourth layer set, or interleaved bits based on the transmitter jointly interleaving first bits in the first layer set, second bits in the second layer set, third bits in the third layer set, and fourth bits in the fourth layer set.

An aspect of the present disclosure includes a transmitting device including means for receiving, from a transmitting device, a transport block including one or more code blocks having a plurality of bits configured to be separated into at least a first layer set and a second layer set of a plurality of layer sets in a first subband a plurality of subbands, and a third layer set and a fourth layer set of the plurality of layer sets in a second subband of the plurality of subbands, each layer set of the plurality of layer sets of each subband of the plurality of subbands has a corresponding modulation order and means for reading the plurality of bits in the one or more code blocks by de-interleaving first bits in the first layer set, second bits in the second layer set, third bits in the third layer set, and fourth bits in the fourth layer set separately, first interleaved bits based on the transmitter interleaving first bits in the first layer set and second bits in the second layer set and second interleaved bits based on the transmitter interleaving third bits in the third layer set and fourth bits in the fourth layer set, first interleaved bits based on the transmitter interleaving first bits in the first layer set and third bits in the third layer set and second interleaved bits based on the transmitter interleaving second bits in the second layer set and fourth bits in the fourth layer set, or interleaved bits based on the transmitter jointly interleaving first bits in the first layer set, second bits in the second layer set, third bits in the third layer set, and fourth bits in the fourth layer set.

Some aspects of the present disclosure include non-transitory computer readable media having instructions stored therein that, when executed by one or more processors of a transmitting device, cause the one or more processors to receive, from a transmitting device, a transport block including one or more code blocks having a plurality of bits configured to be separated into at least a first layer set and a second layer set of a plurality of layer sets in a first subband a plurality of subbands, and a third layer set and a fourth layer set of the plurality of layer sets in a second subband of the plurality of subbands, each layer set of the plurality of layer sets of each subband of the plurality of subbands has a corresponding modulation order and read the plurality of bits in the one or more code blocks by de-interleaving first bits in the first layer set, second bits in the second layer set, third bits in the third layer set, and fourth bits in the fourth layer set separately, first interleaved bits based on the transmitter interleaving first bits in the first layer set and second bits in the second layer set and second interleaved bits based on the transmitter interleaving third bits in the third layer set and fourth bits in the fourth layer set, first interleaved bits based on the transmitter interleaving first bits in the first layer set and third bits in the third layer set and second interleaved bits based on the transmitter interleaving second bits in the second layer set and fourth bits in the fourth layer set, or interleaved bits based on the transmitter jointly interleaving first bits in the first layer set, second bits in the second layer set, third bits in the third layer set, and fourth bits in the fourth layer set.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a wireless communications system and an access network according to aspects of the present disclosure.

FIG. 2 is a schematic diagram of an example of a user equipment according to aspects of the present disclosure.

FIG. 3 is a schematic diagram of an example of a base station according to aspects of the present disclosure.

FIG. 4 illustrates an example of coded bits in a transport block according to aspects of the present disclosure.

FIG. 5 illustrates an example of a first mapping scheme according to aspects of the present disclosure.

FIG. 6 illustrates an example of a second mapping scheme according to aspects of the present disclosure.

FIG. 7 illustrates an example of a third mapping scheme according to aspects of the present disclosure.

FIG. 8 illustrates an example of a fourth mapping scheme according to aspects of the present disclosure.

FIG. 9 illustrates an example of a method for mapping bit into a virtual carrier according to aspects of the present disclosure.

FIG. 10 illustrates an example of a method for receiving and reading mapped bits according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In one aspect of the present disclosure, rate matching and systematic bit priority mapping may be implemented when coded bits are mapped to multiple subbands. In a first aspect, the bits in separate layer sets are mapped separately without interleaving. In a second aspect, the bits in a layer set may be interleaved with bits in another layer set in the subband during the mapping. In a third aspect, the bits in a layer set may be interleaved with bits in another layer set in a different subband. In a fourth aspect, the bits in a layer set may be interleaved with other bits in the same and/or different subbands.

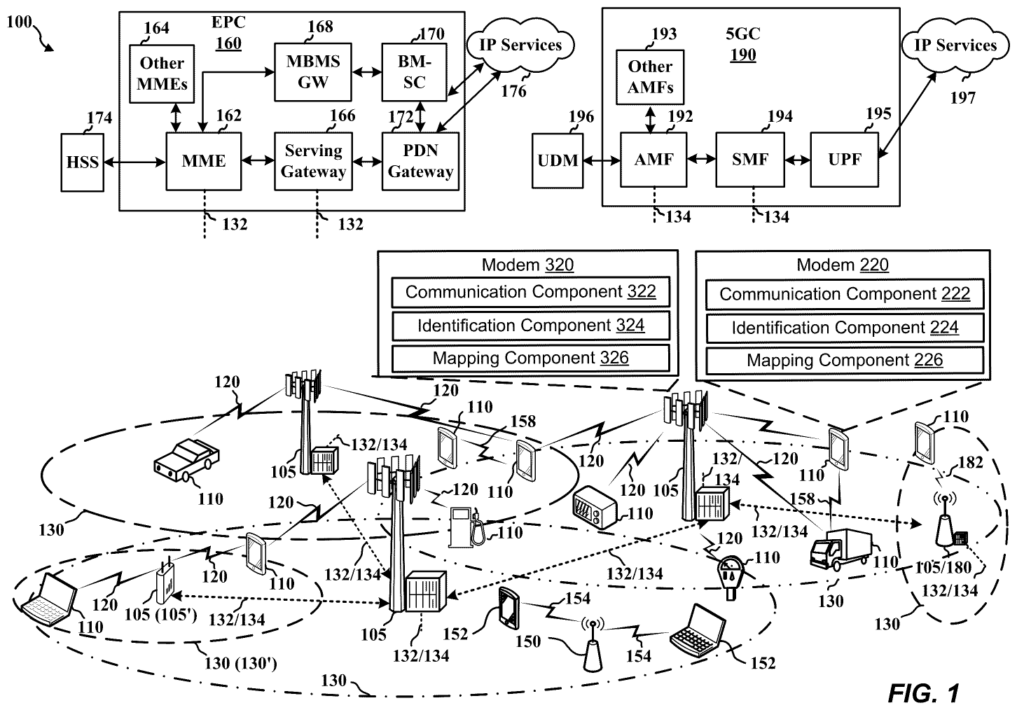

FIG. 1 is a diagram illustrating an example of a wireless communications system and an access network 100. The wireless communications system (also referred to as a wireless wide area network (WWAN)) includes at least one BS 105, UEs 110, an Evolved Packet Core (EPC) 160, and a 5G Core (5GC) 190. The BS 105 may include macro cells (high power cellular base station) and/or small cells (low power cellular base station). The macro cells include base stations. The small cells include femtocells, picocells, and microcells. In one implementation, the UE 110 may include a communication component 222 configured to communicate with the BS 105 via a cellular network, a Wi-Fi network, or other wireless and wired networks. The UE 110 may include an identification component 224 configured to identify a transport block for transmission to a receiver. The UE 110 may include a mapping component 226 configured to map the bits of the transport block to one or more modulated symbols. In some implementations, the communication component 222, the identification component 224, and/or the mapping component 226 may be implemented using hardware, software, or a combination of hardware and software. In some implementations, the BS 105 may include a communication component 322 configured to communicate with the UE 110. The BS 105 may include an identification component 324 configured to identify a transport block for transmission to a receiver. The BS 105 may include a mapping component 326 configured to map the bits of the transport block to one or more modulated symbols. In some implementations, the communication component 322, the identification component 324, and/or the mapping component 326 may be implemented using hardware, software, or a combination of hardware and software.

A BS 105 configured for 4G Long-Term Evolution (LTE) (collectively referred to as Evolved Universal Mobile Telecommunications System (UMTS) Terrestrial Radio Access Network (E-UTRAN)) may interface with the EPC 160 through backhaul links interfaces 132 (e.g., S1, X2, Internet Protocol (IP), or flex interfaces). A BS 105 configured for 5G NR (collectively referred to as Next Generation RAN (NG-RAN)) may interface with 5GC 190 through backhaul links interfaces 134 (e.g., S1, X2, Internet Protocol (IP), or flex interface). In addition to other functions, the BS 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The BS 105 may communicate directly or indirectly (e.g., through the EPC 160 or 5GC 190) with each other over the backhaul links interfaces 134. The backhaul links 132, 134 may be wired or wireless.

The BS 105 may wirelessly communicate with the UEs 110. Each of the BS 105 may provide communication coverage for a respective geographic coverage area 130. There may be overlapping geographic coverage areas 130. For example, the small cell 105′ may have a coverage area 130′ that overlaps the coverage area 130 of one or more macro BS 105. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the BS 105 and the UEs 110 may include uplink (UL) (also referred to as reverse link) transmissions from a UE 110 to a BS 105 and/or downlink (DL) (also referred to as forward link) transmissions from a BS 105 to a UE 110. The communication links 120 may use multiple-input and multiple-output (MIMO) antenna technology, including spatial multiplexing, beamforming, and/or transmit diversity. The communication links may be through one or more carriers. The BS 105/UEs 110 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 110 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 105′ may operate in a licensed and/or an unlicensed frequency spectrum. When operating in an unlicensed frequency spectrum, the small cell 105′ may employ NR and use the same 5 GHz unlicensed frequency spectrum as used by the Wi-Fi AP 150. The small cell 105′, employing NR in an unlicensed frequency spectrum, may boost coverage to and/or increase capacity of the access network.

A BS 105, whether a small cell 105′ or a large cell (e.g., macro base station), may include an eNB, gNodeB (gNB), or other type of base station. Some base stations, such as gNB 180 may operate in one or more frequency bands within the electromagnetic spectrum. The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW/near mmW radio frequency band has extremely high path loss and a short range. The mmW base station 180 may utilize beamforming 182 with the UE 110 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 110 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a packet switched (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the BS 105 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The BS 105 may also be referred to as a gNB, Node B, evolved Node B (CNB), an access point, a base transceiver station, a radio base station, an access point, an access node, a radio transceiver, a NodeB, cNodeB (CNB), gNB, Home NodeB, a Home eNodeB, a relay, a transceiver function, a basic service set (BSS), an extended service set (ESS), a transmit reception point (TRP), or some other suitable terminology. The BS 105 provides an access point to the EPC 160 or 5GC 190 for a UE 110. Examples of UEs 110 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 110 may be referred to as IoT devices (e.g., parking meter, gas pump, toaster, vehicles, heart monitor, etc.). The UE 110 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

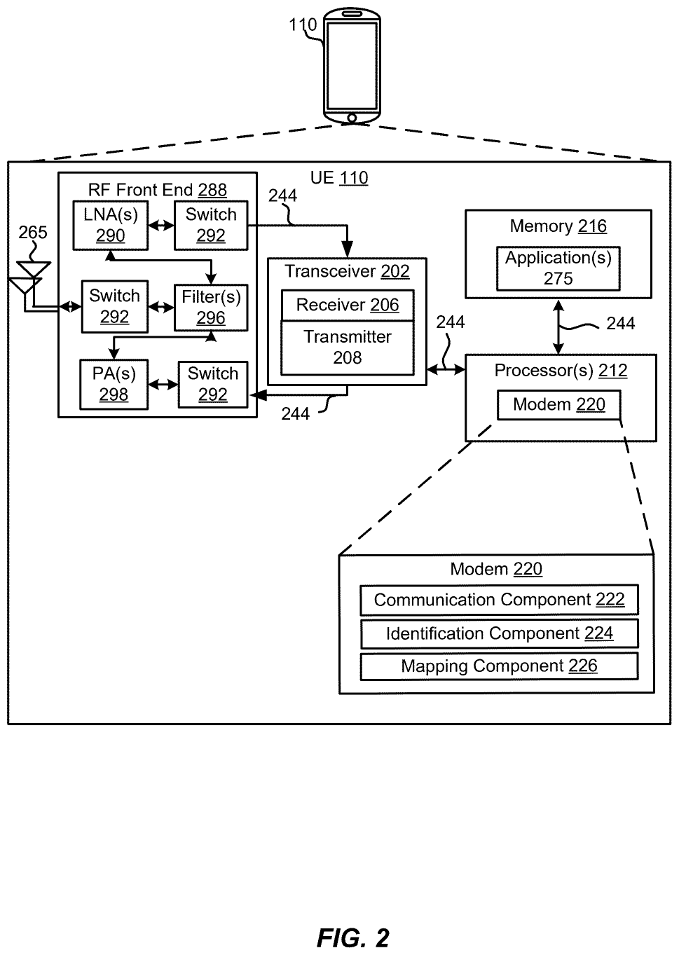

Referring to FIG. 2, one example of an implementation of the UE 110 may include a modem 220 having the communication component 222, the identification component 224, and/or the mapping component 226. In one implementation, the UE 110 may include a communication component 222 configured to communicate with the BS 105 via a cellular network, a Wi-Fi network, or other wireless and wired networks. The UE 110 may include an identification component 224 configured to identify a transport block for transmission to a receiver. The UE 110 may include a mapping component 226 configured to map the bits of the transport block to one or more modulated symbols.

In some implementations, the UE 110 may include a variety of components, including components such as one or more processors 212 and memory 216 and transceiver 202 in communication via one or more buses 244, which may operate in conjunction with the modem 220 and the communication component 222 to enable one or more of the functions described herein related to communicating with the BS 105. Further, the one or more processors 212, modem 220, memory 216, transceiver 202, RF front end 288 and one or more antennas 265, may be configured to support voice and/or data calls (simultaneously or non-simultaneously) in one or more radio access technologies. The one or more antennas 265 may include one or more antennas, antenna elements and/or antenna arrays.

In an aspect, the one or more processors 212 may include the modem 220 that uses one or more modem processors. The various functions related to the communication component 222, the identification component 224, and/or the mapping component 226 may be included in the modem 220 and/or processors 212 and, in an aspect, may be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiving device processor, or a transceiver processor associated with transceiver 202. Additionally, the modem 220 may configure the UE 110 along with the processors 212. In other aspects, some of the features of the one or more processors 212 and/or the modem 220 associated with the communication component 222 may be performed by transceiver 202.

The memory 216 may be configured to store data used and/or local versions of application 275. Also, the memory 216 may be configured to store data used herein and/or local versions of the communication component 222, the identification component 224, and/or the mapping component 226, and/or one or more of the subcomponents being executed by at least one processor 212. Memory 216 may include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining the communication component 222, the identification component 224, and/or the mapping component 226, and/or one or more of the subcomponents, and/or data associated therewith, when UE 110 is operating at least one processor 212 to execute the communication component 222, the identification component 224, and/or the mapping component 226, and/or one or more of the subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a RF receiving device. In an aspect, the receiver 206 may receive signals transmitted by at least one BS 105. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 110 may include RF front end 288, which may operate in communication with one or more antennas 265 and transceiver 202 for receiving and transmitting radio transmissions, for example, wireless communications transmitted by at least one BS 105 or wireless transmissions transmitted by UE 110. RF front end 288 may be coupled with one or more antennas 265 and may include one or more low-noise amplifiers (LNAs) 290, one or more switches 292, one or more power amplifiers (PAS) 298, and one or more filters 296 for transmitting and receiving RF signals.

In an aspect, LNA 290 may amplify a received signal at a desired output level. In an aspect, each LNA 290 may have a specified minimum and maximum gain values. In an aspect, RF front end 288 may use one or more switches 292 to select a particular LNA 290 and the specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and the specified gain value based on a desired gain value for a particular application.

Also, for example, one or more filters 296 may be used by RF front end 288 to filter a received signal to obtain an input RF signal. Similarly, in an aspect, for example, a respective filter 296 may be used to filter an output from a respective PA 298 to produce an output signal for transmission. In an aspect, each filter 296 may be coupled with a specific LNA 290 and/or PA 298. In an aspect, RF front end 288 may use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 110 may communicate with, for example, one or more BS 105 or one or more cells associated with one or more BS 105. In an aspect, for example, the modem 220 may configure transceiver 202 to operate at a specified frequency and power level based on the UE configuration of the UE 110 and the communication protocol used by the modem 220.

In an aspect, the modem 220 may be a multiband-multimode modem, which may process digital data and communicate with transceiver 202 such that the digital data is sent and received using transceiver 202. In an aspect, the modem 220 may be multiband and be configured to support multiple frequency bands for a specific communications protocol. In an aspect, the modem 220 may be multimode and be configured to support multiple operating networks and communications protocols. In an aspect, the modem 220 may control one or more components of UE 110 (e.g., RF front end 288, transceiver 202) to enable transmission and/or reception of signals from the network based on a specified modem configuration. In an aspect, the modem configuration may be based on the mode of the modem and the frequency band in use. In another aspect, the modem configuration may be based on UE configuration information associated with UE 110 as provided by the network.

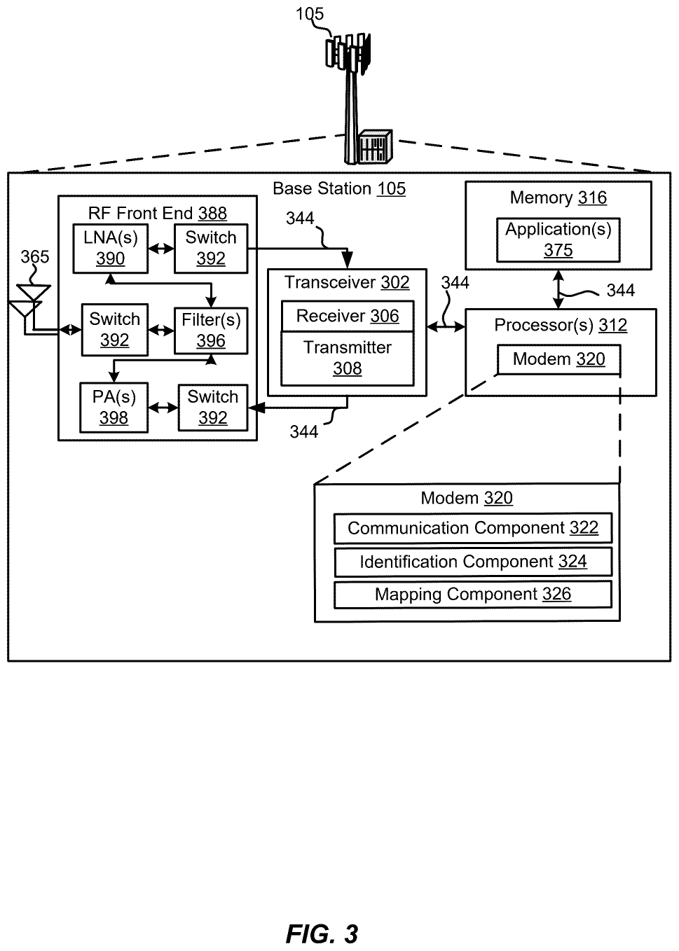

Referring to FIG. 3, one example of an implementation of the BS 105 may include a modem 320 having the communication component 322, the identification component 324, and/or the mapping component 326. In some implementations, the BS 105 may include a communication component 322 configured to communicate with the UE 110. The BS 105 may include an identification component 324 configured to identify a transport block for transmission to a receiver. The BS 105 may include a mapping component 326 configured to map the bits of the transport block to one or more modulated symbols.

In some implementations, the BS 105 may include a variety of components, including components such as one or more processors 312 and memory 316 and transceiver 302 in communication via one or more buses 344, which may operate in conjunction with the modem 320 and the communication component 322 to enable one or more of the functions described herein related to communicating with the UE 110. Further, the one or more processors 312, modem 320, memory 316, transceiver 302, RF front end 388 and one or more antennas 365, may be configured to support voice and/or data calls (simultaneously or non-simultaneously) in one or more radio access technologies.

In an aspect, the one or more processors 312 may include the modem 320 that uses one or more modem processors. The various functions related to the communication component 322, the identification component 324, and/or the mapping component 326 may be included in the modem 320 and/or processors 312 and, in an aspect, may be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiving device processor, or a transceiver processor associated with transceiver 302. Additionally, the modem 320 may configure the BS 105 and processors 312. In other aspects, some of the features of the one or more processors 312 and/or the modem 320 associated with the communication component 322 may be performed by transceiver 302.

The memory 316 may be configured to store data used herein and/or local versions of applications 375. Also, the memory 316 may be configured to store data used herein and/or local versions of the communication component 322, the identification component 324, and/or the mapping component 326, and/or one or more of the subcomponents being executed by at least one processor 312. Memory 316 may include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining the communication component 322, the identification component 324, and/or the mapping component 326, and/or one or more of the subcomponents, and/or data associated therewith, when the BS 105 is operating at least one processor 312 to execute the communication component 322, the identification component 324, and/or the mapping component 326, and/or one or more of the subcomponents.

Transceiver 302 may include at least one receiver 306 and at least one transmitter 308. The at least one receiver 306 may include hardware, firmware, and/or software code executable by a processor for receiving data, the code comprising instructions and being stored in a memory (e.g., computer-readable medium). The receiver 306 may be, for example, a RF receiving device. In an aspect, receiver 306 may receive signals transmitted by the UE 110. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, the BS 105 may include RF front end 388, which may operate in communication with one or more antennas 365 and transceiver 302 for receiving and transmitting radio transmissions, for example, wireless communications transmitted by other BS 105 or wireless transmissions transmitted by UE 110. RF front end 388 may be coupled with one or more antennas 365 and may include one or more low-noise amplifiers (LNAs) 390, one or more switches 392, one or more power amplifiers (PAS) 398, and one or more filters 396 for transmitting and receiving RF signals.

In an aspect, LNA 390 may amplify a received signal at a desired output level. In an aspect, each LNA 390 may have a specified minimum and maximum gain values. In an aspect, RF front end 388 may use one or more switches 392 to select a particular LNA 390 and the specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and the specified gain value based on a desired gain value for a particular application.

Also, for example, one or more filters 396 may be used by RF front end 388 to filter a received signal to obtain an input RF signal. Similarly, in an aspect, for example, a respective filter 396 may be used to filter an output from a respective PA 398 to produce an output signal for transmission. In an aspect, each filter 396 may be coupled with a specific LNA 390 and/or PA 398. In an aspect, RF front end 388 may use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that BS 105 may communicate with, for example, the UE 110 or one or more cells associated with one or more BS 105. In an aspect, for example, the modem 320 may configure transceiver 302 to operate at a specified frequency and power level based on the base station configuration of the BS 105 and the communication protocol used by the modem 320.

In an aspect, the modem 320 may be a multiband-multimode modem, which may process digital data and communicate with transceiver 302 such that the digital data is sent and received using transceiver 302. In an aspect, the modem 320 may be multiband and be configured to support multiple frequency bands for a specific communications protocol. In an aspect, the modem 320 may be multimode and be configured to support multiple operating networks and communications protocols. In an aspect, the modem 320 may control one or more components of the BS 105 (e.g., RF front end 388, transceiver 302) to enable transmission and/or reception of signals from the network based on a specified modem configuration. In an aspect, the modem configuration may be based on the mode of the modem and the frequency band in use. In another aspect, the modem configuration may be based on base station configuration associated with the BS 105.

In some aspects, the transport block size (TBS) may be determined as follows. First, the number of resource elements (REs) allocated for physical downlink share channel (PDSCH) and/or physical uplink shared channel (PUSCH) within a physical resource block (PRB) may be determined using this formula:

$${N}_{RB}^{′} = {N}_{sc}^{RB} \cdot {N}_{symb}^{sh} - {N}_{DMRS}^{PRB} - {N}_{oh}^{PRB} .$$

Next, the scheme determines the number of REs allocated for PDSCH/PUSCH

$${N}_{RE} = min ( 1 \; 56 , {N}_{R E}^{′} ) \cdot {n}_{PRB} .$$

Unquantized intermediate variable is obtained by N_{info}=N_{RE}·R·Qₘ·v. Finally, N_{info} is then used to determine the closest TBS from tables.

In certain aspects of the present disclosure, code block (CB) segmentation may be performed for a TB when B>K_{cb} where K_{cb} is the maximum code block size, and B is the TBS. If CB segmentation is performed, then additional CRC sequence of L=24 bits may be attached to each CB. For base graph 1: K_{cb}=8448. For base graph 2: K_{cb}=3840. The input to this step may be b₀, b₁, . . . , b_{B-1}. The output of this step, assuming CB segmentation is performed, is Cᵣ_{₀}, Cᵣ_{₁}, Cᵣ_{₂}, . . . , Cᵣ_{_{(Kr−1)}}. Here, 0≤r<C is the code block number, and Kᵣ=K is the number of bits for the code block number r.

In one aspect, in the next step (e.g., encoding step), the input to this step is Cᵣ_{₀}, Cᵣ_{₁}, Cᵣ_{₁}, . . . , Cᵣ_{_{(kr−1)}}. The output sequence is denoted by d₀, d₁, d₂, . . . , d_{N-1} where N=66Z_{c} for the low-density parity-check (LDPC) base graph 1 and N=50Z_{c} for LDPC base graph 2. For the bit selection process, the bit sequence after encoding, d₀, d₁, d₂, . . . , d_{N-1}, may written into a circular buffer of length N_{cb} for the r-th code block. If L_{BRM}=0, N_{cb}=N, otherwise, N_{cb}=min (N, N_{ref}) with

$${N}_{ref} = ⌊ \frac{{TBS}_{LBRM}}{C \cdot {R}_{LBRM}} ⌋ .$$

Here, N is the code length (e.g., number of coded bits of the mother code) with the following lengths: code length=3k bits (for BG1) or 5k bits (for BG2), where k is the number of info bits of one CB, C is the number of CBs (of the actual TB, not Max TB), R_{LBRM} may be a fixed code rate (such as ⅔), and TBS_{LBRM} is the Max TBS assuming max # of layers for one TB, max mod order, max code rate of 0.926, max number of data REs=156*n_{PRB-LBRM}. The rate matching output sequence length of the r-th code block, denoted by Eᵣ, is given by:

$${E}_{r} = {N}_{L} \cdot {Q}_{m} \cdot ⌊ \frac{G}{{N}_{L} \cdot {Q}_{m} \cdot {C}^{′}} ⌋ ,$$

with the following denotation: G: total number of coded bits available for transmission of the transport block, N_{L}: number of transmission layers that the transport block is mapped onto, Qₘ: modulation order, and C′=C if CBGTI is not present. Depending on the redundancy version (RV) index, the output bit sequence is generated: ex: k=0,1,2, . . . , E−1 reading from the circular buffer starting with the coded bit as determined by the RV index.

In some aspects, for bit interleaving, the last step is SBPM (systematic bit priority mapping) to put the systematic bits into the most significant bits (MSBs) of the modulated symbols. A rectangular interleaver may be used for interleaving according to aspects of the present disclosure, where the number of rows (or columns) may be a function of the modulation order Qₘ.

In certain aspects, flexible spectrum integration (FSI) may be implemented to unify physical (PHY) and medium access control (MAC) across component carriers (CCs). One aspect of FSI includes integrating CCs (in the same or different bands) to form a virtual carrier/cell. With a single cell, scheduling and implementing hybrid automatic repeat request (HARQ) may include one or more advantages such as one CC worth of physical downlink channel (PDCCH) for scheduling, smaller decoding attempts plus narrow radio frequency (RF) for PDCCH, and/or unifying re-transmissions across subbands (SBs) for better diversity. In this case, the virtual CC (or carrier or cell) may contain multiple CCs or SBs, that may be contiguous or non-contiguous.

In some aspects, there may be different ways of TB schedule across aggregated SBs. One aspect includes integrating the small and scattered frequency division duplex (FDD) channels as one large virtual carrier with a single-TB scheduling. Another aspect includes multi-TB scheduling with a single-CC PDCCH for large aggregated bandwidth (BW). For BW adaptation using bandwidth part (BWP) mechanism, one aspect includes low latency adaptation when needed depending on UE's RF BW and configured measurements.

In certain aspects of the present disclosure, FSI with a single PDSCH or PUSCH schedule and/or mapping may be implemented as follows. Each TB is mapped onto a non-contiguous BWP activated within a virtual cell. Single-CC PDCCH blind detection may be performed on the anchor SB. TB may be mapped across SBs with a CB-level interleaving such that each CB is mapped to all or most SBs. A TB spanning different SBs may be scheduled with different link parameters such modulation order and rank.

In one aspect of the present disclosure, in convention systems, when the number of layers is beyond a threshold (larger than 4 in NR or larger than 1 in LTE), more than one TB/CW may be required. The first set of layers may be mapped to TB1/CW1 (with a first modulation and coding scheme (MCS)) and second set of layers may be mapped to TB2/CW2 (with a second MCS). This is because the channel quality/capacity may not be the same across all layers. Hence, there is benefit in sending different TBs with different link parameters (code rate/modulation order) on different sets of layers.

Aspects of the present disclosure include mapping bits where the modulation order may change across SBs and/or layers as described below. In one aspect, instead of sending different TBs with different MCS, same TB (single TB) is transmitted but different modulation orders are used for different sets of layers. In one aspect, for the rate matching and SBPM bit interleaving, the following cases can be considered when coded bits of a TB are mapped to multiple SBs each with one or more sets of spatial layers. The first case includes mapping the bits that are separate across layer sets and separate across SBs. The second case includes mapping the bits that are joint across layer sets and separate across SBs. The third case includes mapping the bits that are separate across layer sets and joint across SBs. The fourth case includes mapping the bits that are joint across layer sets and across SBs.

In some aspects, in cases above and below, it is denoted that the modulation order for the pair of (SBᵢ, layer setⱼ)=Q_{i,j}, where i=1, 2, . . . , I is the SB index and j=1,2, . . . J is the index of a set of layers in that SB. In general, the number of layers sets (J) can depend on the SB, i.e., it is possible that some of the SBs have a single layer set (with same modulation order), some other SBs have two layer sets (with two different modulation orders), and remaining SBs have three or more layer sets (with three or more different modulation orders). The number of layer sets (J) for each SB may be explicitly indicated by the network (in scheduling DCI or other indicators) or can be based on number of layers of that SB (e.g., if # of layers is larger than a threshold such as 2 or 4, J=2; otherwise, J=1). The value of the modulation order Q_{i,j} for all pairs may be indicated by the network (e.g., in scheduling DCI or other indicators).

In certain aspects, for the descriptions in the present disclosure, it is denoted that the number of coded bits for the pair of (SBᵢ, layer setⱼ)=E_{i,j}, where i=1, 2, . . . , I is the SB index and j=1, 2, . . . , J is the index of a set of layers in that SB.

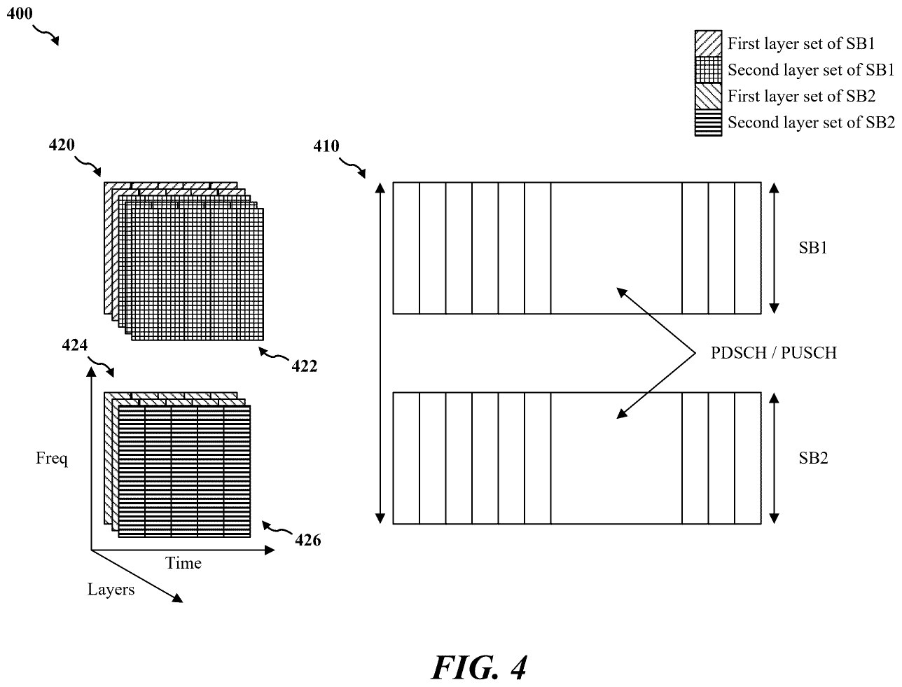

FIG. 4 illustrates an example of coded bits in a transport block. A scheme 400 for transmitting the coded bits in a virtual carrier 410 is shown. In FIG. 4, resources with upward diagonal patterns ( [symbol] ) are the first layer set of SB1. Resources with grid patterns ( [symbol] ) are the second layer set of SB1. Resources with downward diagonal patterns ( [symbol] ) are the first layer set of SB2. Resources with horizontal line patterns ( [symbol] ) are the second layer set of SB2. Specifically, aspects of the present disclosure includes mapping coded bits into the virtual carrier 410 as described below. In some aspects of the present disclosure, bits in n SBs each with m layer sets may be mapped, where n and m are positive integers that may be the same or different. In the non-limiting example shown in FIG. 4, there are 2 SBs each with 2 layer sets. However, the number of SBs and/or the number of layer sets may be the same or different as shown in FIG. 4 according to various aspects of the present disclosure.

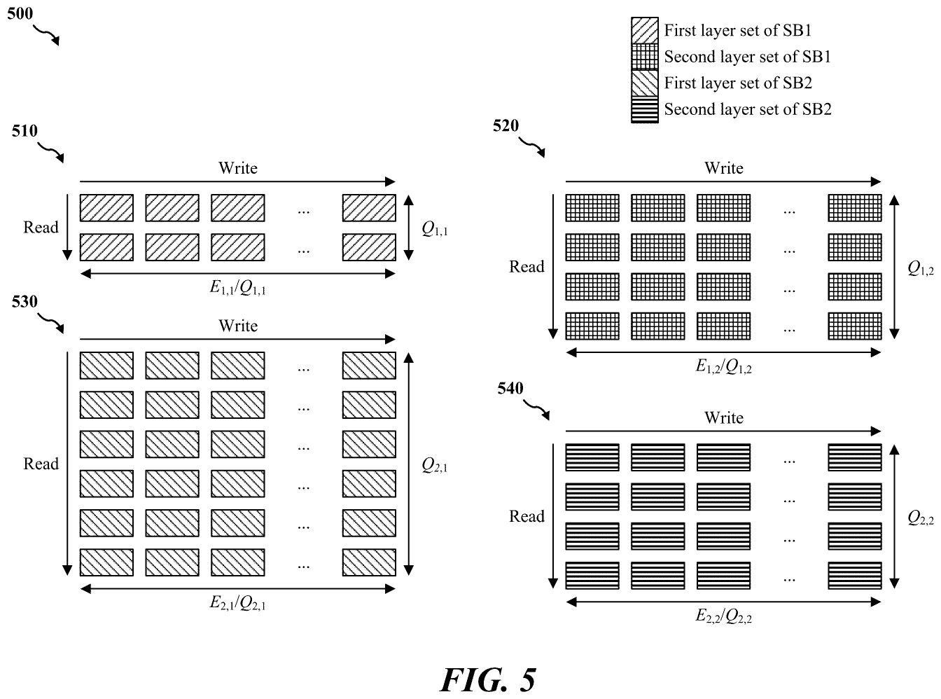

A first layer set 420 of SB1 may include E_{1.1} coded bits with modulation order of Q_{1.1} (e.g., 2). A second layer set 422 of SB1 may include E_{1.2} coded bits with modulation order Q_{1.2} (e.g., 4). A third layer set 424 of SB2 may include E_{2.1} coded bits with modulation order Q_{2.1} (e.g., 6). A fourth layer set 426 of SB2 may include E_{2,2} coded bits with modulation order Q_{2,2} (e.g., 4). Other numbers of layer sets, SBs, coded bits, and/or modulation orders may also be implemented according to aspects of the present disclosure. The total number of coded bits of the TB mapped to all SBs and all layer sets Eᵣ=E_{1.1}+E_{1.2}+E_{2.1}+E_{2.2}. Here, the mapped bits may be transmitted in the SBs of PUSCH and/or PDSCH. The mapping may be implemented according to any one of the mapping schemes shown in FIGS. 5-8 and/or described below.

For the de-mapping process, modulated symbols in each mapped block is read according the mapping scheme used. In one aspect, for a rectangular interleaver mapping scheme, coded bits are mapped to one or more modulated symbols. The coded bits are written to the rows of the mapped block. For the de-mapping process, the coded bits are reconstructed by sequentially reading each column of the mapped block. As such, the most significant bits of the modulated symbols may be read first, followed by the next most significant bits of the modulated symbols, and so forth and so on. The de-mapping process may reconstruct the data bits after reading the one or more modulated symbols in the mapped block.

In the present disclosure, mapping and de-mapping refer to the writing or reading of data bits to or from a mapped block, respectively. The data bits may be mapped into modulated symbols. Further, in the present disclosure, interleaving and de-interleaving refer to the mixing or unmixing of the data bits, respectively, in a mapped data block.

Aspects of the present disclosure include interleaving coded bits and/or de-interleaving coded bits according to one or more schemes described below. Each scheme includes interleaving coded bits of a layer set alone or in combination with coded bits of other layer sets, and/or de-interleaving coded bits of a layer set separately or interleaved with coded bits of other layer sets.

FIG. 5 illustrates an example of a first mapping scheme. In FIG. 5, resources with upward diagonal patterns ( [symbol] ) are the first layer set of SB1. Resources with grid patterns ( [symbol] ) are the second layer set of SB1. Resources with downward diagonal patterns ( [symbol] ) are the first layer set of SB2. Resources with horizontal line patterns ( [symbol] ) are the second layer set of SB2. The mapped blocks shown in FIG. 5 are the results of a transmitter performing a mapping of coded bits in various layers and/or SBs, such as the first and second layers of SB 1 and first and second layers of SB2 shown in FIG. 4. Here, the coded bits in the various layers are mapped to four data blocks as described below.

In a first mapping scheme 500, the bits in each layer set are not interleaved with bits from other layer sets. Instead, rectangular interleaving is performed for each layer set separately from other layer sets. The notations and/or subscripts are described above. Referring to FIGS. 4 and 5, in the first mapping scheme 500, bits in the first layer set 420 are interleaved into a first mapped block 510 having a modulation order of 2 (i.e., 2 rows) and

$$\frac{{E}_{1 , 1}}{{Q}_{1 , 1}}$$

columns (number of total bits in the first layer set 420, E_{1.1}, divided by the modulation order of the first layer set 420, Q_{1.1}). Bits in the second layer set 422 are interleaved into a second mapped block 520 having a modulation order of 4 (i.e., 4 rows) and

$$\frac{{E}_{1 , 2}}{{Q}_{1 , 2}}$$

columns (number of total bits in the second layer set 422, E_{1,2}, divided by the modulation order of the second layer set 422, Q_{1.2}). Bits in the third layer set 424 are interleaved into a third mapped block 530 having a modulation order of 6 (i.e., 6 rows) and

$$\frac{{E}_{2 , 1}}{{Q}_{2 , 1}}$$

columns (number of total bits in the third layer set 424, E_{2,1}, divided by the modulation order of the third layer set 424, Q_{2.1}). Bits in the fourth layer set 426 are interleaved into a fourth mapped block 540 having a modulation order of 4 (i.e., 4 rows) and

$$\frac{{E}_{2 , 2}}{{Q}_{2 , 2}}$$

columns (number of total bits in the fourth layer set 426, E_{2.2}, divided by the modulation order of the fourth layer set 426, Q_{2.2}). As illustrated, bit interleaving (such as SBPM interleaving) is done separately for each layer set of each SB, where each of the four interleavers is a rectangular interleaver and the coded bits are written by rows and are read by columns.

In some aspects, the first mapping scheme 500 shown in FIG. 5, the coded bits in each of the mapped blocks 510, 520, 530, 540 are interleaved as a part of the mapping process. Specifically, the coded bits are written “horizontally” into the rows of the mapped blocks 510, 520, 530, 540 and the coded bits are read “vertically” out of the columns of the mapped blocks 510, 520, 530, 540. As such, the interleaving process may place certain bits into the most significant bits positions of the modulated symbols and other bits into the least significant bits positions of the modulated symbols. Additionally, the interleaving process allows the receiving device to read certain bits of each symbol first (e.g., most significant bits first) and read other bits of each symbol subsequently instead of reading one symbol (entirely) at a time.

In some aspects of the present disclosure, a receiver may receive the mapped blocks above and read the coded bits without de-interleaving the coded bits interleaved among two or more layer sets (since the coded bits are not interleaved with other layer sets in the current scheme). The receiver may de-map the mapped blocks 510, 520, 530, 540 by de-interleaving and reading the coded bits column by column to reconstruct the first layer set 420, the second layer set 422, the third layer set 424, and the fourth layer set 426, respectively, as described above. Specifically, the receiver may de-interleave each of the mapped blocks 510, 520, 530, 540 separately (e.g., de-interleaving the mapped blocks interleaved via a rectangular interleaver) by reading the coded bits by columns. As such, the receiver may read certain bits of the modulated symbols first followed by other bits of the modulated symbols.

In FIG. 5, the interleaving process relates to placing (and reading) coded bits of a layer set into (and from) a mapped block without “mixing” with coded bits of other layer sets. Accordingly, the interleaving process includes arranging the coded bits as described above. In contrast, other aspects of the present disclosure include interleaving coded bits of a layer set with coded bits of other layer sets (as described below). Accordingly, the interleaving process includes arranging the coded bits of multiple layer sets into one or more mapped blocks.

In FIG. 5, the layer sets are shown as having modulations orders of 2, 4, and 6. However, aspects of the present disclosure include layers sets having different modulation orders. Specifically, certain aspects of the present disclosure include mapping and interleaving layer sets have different modulation orders (e.g., any number between 1-10, 1-20, 1-30, or other numbers and/or ranges of layers). Further, the layer sets are shown as having 1, 2, or 3 layers. However, aspects of the present disclosure include layer sets having different number of layers (e.g., any number between 1-14, 1-23, 1-40, or other numbers and/or ranges of layers).

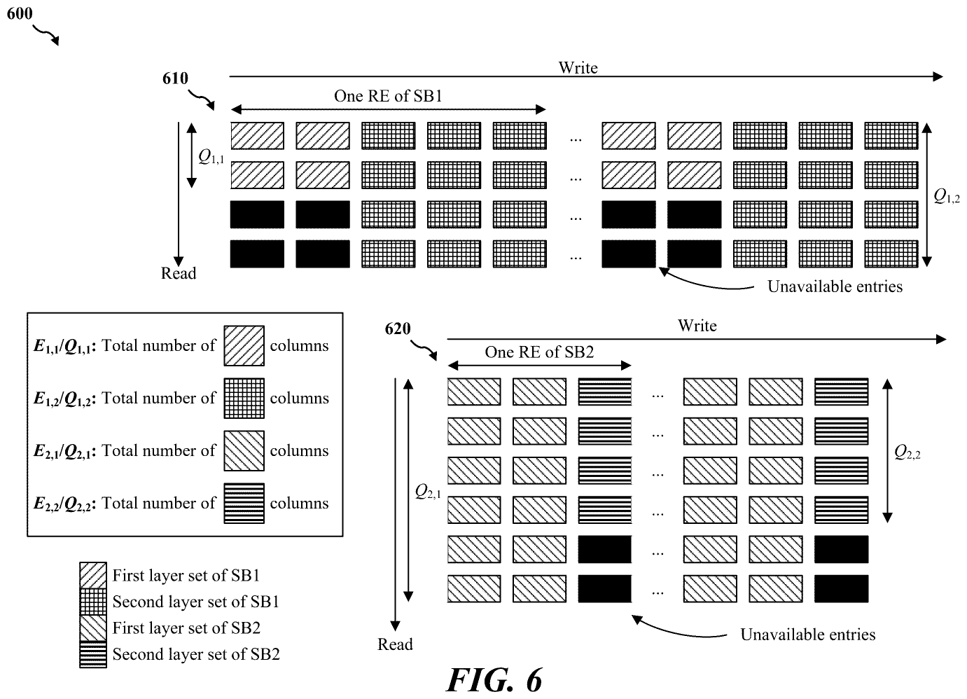

FIG. 6 illustrates an example of a second mapping scheme. In FIG. 6, resources with upward diagonal patterns ( [symbol] ) are the first layer set of SB1. Resources with grid patterns ( [symbol] ) are the second layer set of SB1. Resources with downward diagonal patterns ( [symbol] ) are the first layer set of SB2. Resources with horizontal line patterns ( [symbol] ) are the second layer set of SB2. The mapped blocks shown in FIG. 6 are the results of a transmitter performing a mapping and/or interleaving of coded bits in various layers and/or SBs, such as the first and second layers of SB1 and first and second layers of SB2 shown in FIG. 4. Here, the coded bits in the various layers are mapped and/or interleaved into data blocks as described below.

According to certain aspects of the present disclosure, in a second mapping scheme 600, the bits in each layer set are interleaved with bits from layer sets in the same SB. Each RE of a mapped block may include coded bits from each layer set in the same SB. The notations and/or subscripts are described above. Referring to FIGS. 4 and 6, in the second mapping scheme 600, bits in the first layer set 420 are interleaved with bits in the second layer set 422 into a first mapped block 610. The first layer set 420 has a modulation order of 2 (i.e., 2 rows in a RE of SB1) and the second layer set 422 has a modulation order of 4 (i.e., 4 rows in a RE of SB1). Since the modulation orders are different, unavailable entries are placed into the first mapped block 610 to achieve rate matching. The total number of columns for the first layer set 420 is

$$\frac{{E}_{1 , 1}}{{Q}_{1 , 1}}$$

columns (number of total bits in the first layer set 420, E_{1.1}, divided by the modulation order of the first layer set 420, Q_{1.1}) and the total number of columns for the second layer set 422 is

$$\frac{{E}_{1 , 2}}{{Q}_{1 , 2}}$$

columns (number of total bits in the second layer set 422, E_{1,2}, divided by the modulation order of the second layer set 422, Q_{1.2}). Further, for each RE, there are 2 columns of coded bits from the first layer set 420 because the first layer set 420 has 2 layers, and 3 columns of coded bits from the second layer set 422 because the second layer set 422 has 3 layers.

Here, the unavailable entries may be null entries where no information is written to the unavailable entries during the mapping/interleaving process, and no information is read from the unavailable entries during the de-mapping/de-interleaving process. In alternative aspects, the unavailable entries may include control information, beacon signals, error correction information, padding bits, or other types of entries. In certain aspects, the unavailable entries may include entries that include data to be read by the receiver. Other aspects of the entries may be implemented according to various aspects of the present disclosure.

In some aspects of the present disclosure, the unavailable entries exist to achieve rate matching in the second mapping scheme 600. Specifically, in each RE of the first mapped block 610, there are 2 columns of coded bits from the first layer set 420 because the first layer set 420 has 2 layers, and 3 columns of coded bits from the second layer set 422 because the second layer set 422 has 3 layers. There are 2 rows of coded bits from the first layer set 420 because the first layer set 420 has a modulation order of 2, and 4 rows of coded bits from the second layer set 422 because the second layer set 422 has a modulation order of 4. Consequently, there are 4 (2×2) unavailable entries in each RE of the first mapped block 610.

Still referring to FIGS. 4 and 6, in some aspects of the present disclosure, in the second mapping scheme 600, bits in the third layer set 424 are interleaved with bits in the fourth layer set 426 into a second mapped block 620. The third layer set 424 has a modulation order of 6 (i.e., 6 rows in a RE of SB2) and the fourth layer set 426 has a modulation order of 4 (i.e., 4 rows in a RE of SB2). Since the modulation orders are different, unavailable entries are placed into the second mapped block 620 to achieve rate matching. The total number of columns for the third layer set 424 is

$$\frac{{E}_{2 , 1}}{{Q}_{2 , 1}}$$

columns (number of total bits in the third layer set 424, E_{2.1}, divided by the modulation order of the third layer set 424, Q_{2.1}) and the total number of columns for the fourth layer set 426 is

$$\frac{{E}_{2 , 2}}{{Q}_{2 , 2}}$$

columns (number of total bits in the fourth layer set 426, E_{2,2}, divided by the is modulation order of the fourth layer set 426, Q_{2.2}). Further, for each RE, there are 2 columns of coded bits from the third layer set 424 because the third layer set 424 has 2 layers, and 1 column of coded bits from the fourth layer set 426 because the fourth layer set 426 has 1 layer. As illustrated, the bit interleaving (such as SBPM interleaving) is joint across multiple layers sets of a given SB, but is separate across different SBs. For each of the two interleavers, the interleaver may not be strictly rectangular since different layers sets of a given SB may have different modulation order. For each of the two interleavers, the coded bits are written by rows and are read by columns while excluding the unavailable entries.

Here, the unavailable entries may be null entries where no information is written to the unavailable entries during the mapping/interleaving process, and no information is read from the unavailable entries during the de-mapping/de-interleaving process. In alternative aspects, the unavailable entries may include control information, beacon signals, error correction information, padding bits, or other types of entries. In certain aspects, the unavailable entries may include entries that include data to be read by the receiver. Other aspects of the entries may be implemented according to various aspects of the present disclosure.

In some aspects of the present disclosure, the unavailable entries exist to achieve rate matching in the second mapping scheme 600. Specifically, in each RE of the second mapped block 620, there are 2 columns of coded bits from the third layer set 424 because the third layer set 424 has 2 layers, and 1 column of coded bits from the fourth layer set 426 because the fourth layer set 426 has 1 layer. There are 6 rows of coded bits from the third layer set 424 because the third layer set 424 has a modulation order of 6, and 4 rows of coded bits from the fourth layer set 426 because the fourth layer set 426 has a modulation order of 4. Consequently, there are 2 (2×1) unavailable entries in each RE of the second mapped block 620.

In some aspects of the present disclosure, a receiver may receive the mapped blocks above and read the coded bits by de-interleaving each RE of the mapped blocks. The receiver may de-map the mapped blocks 610, 620 by reading the coded bits column by column to reconstruct the first layer set 420, the second layer set 422, the third layer set 424, and the fourth layer set 426, respectively, as described above. In one aspect of the present disclosure, the receiver may de-map the mapped blocks 610, 620, and de-interleave each RE of each of the mapped blocks 610, 620 to extract the coded bits for each of the first layer set 420, the second layer set 422, the third layer set 424, and the fourth layer set 426.

For example, the receiver may de-map the first mapped block 610, and de-interleave each RE of the first mapped block 610 by identifying the first two columns of coded bits of each RE as belonging to the first layer set 420 and the next three columns of coded bits of each RE as belonging to the second layer set 422. The receiver may de-map the second mapped block 620, and de-interleave each RE of the second mapped block 620 by identifying the first two columns of coded bits of each RE as belonging to the third layer set 424 and the next column of coded bits of each RE as belonging to the fourth layer set 426.

In FIG. 6, the layer sets are shown as having modulations orders of 2, 4, and 6. However, aspects of the present disclosure include layers sets having different modulation orders. Specifically, certain aspects of the present disclosure include mapping and interleaving layer sets have different modulation orders (e.g., any number between 1-6, 1-13, 1-22, or other numbers and/or ranges of layers). Further, the layer sets are shown as having 1, 2, or 3 layers. However, aspects of the present disclosure include layer sets having different number of layers (e.g., any number between 1-8, 1-11, 1-25, or other numbers and/or ranges of layers).

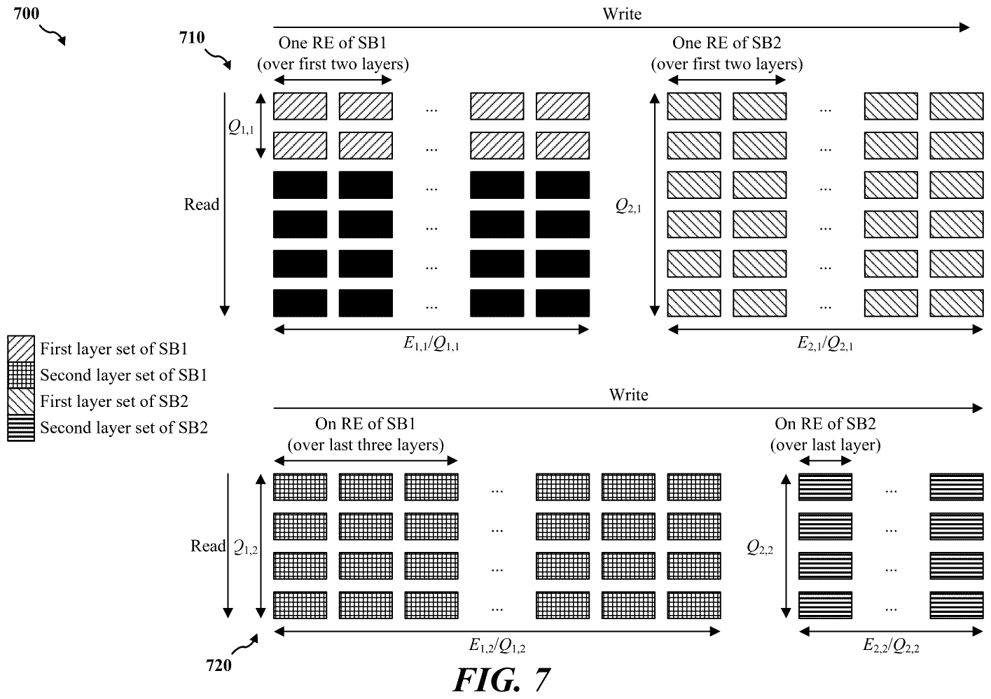

FIG. 7 illustrates an example of a third mapping scheme. In FIG. 7, resources with upward diagonal patterns ( [symbol] ) are the first layer set of SB1. Resources with grid patterns ( [symbol] ) are the second layer set of SB1. Resources with downward diagonal patterns ( [symbol] ) are the first layer set of SB2. Resources with horizontal line patterns ( [symbol] ) are the second layer set of SB2. The mapped blocks shown in FIG. 7 are the results of a transmitter performing a mapping and/or interleaving of coded bits in various layers and/or SBs, such as the first and second layers of SB1 and first and second layers of SB2 shown in FIG. 4. Here, the coded bits in the various layers are mapped and/or interleaved into data blocks as described below.

According to some aspects of the present disclosure, in a third mapping scheme 700, the bits in each layer set are interleaved with bits from layer sets in a different SB. Each RE of a mapped block may include coded bits from a layer set. The notations and/or subscripts are described above. Referring to FIGS. 4 and 7, in the third mapping scheme 700, bits in the first layer set 420 are interleaved with bits in the third layer set 424 into a first mapped block 710. The first layer set 420 has a modulation order of 2 (i.e., 2 rows in a RE of SB1) and the third layer set 424 has a modulation order of 6 (i.e., 6 rows in a RE of SB2). Since the modulation orders are different, unavailable entries are placed into the first mapped block 710 to achieve rate matching. The total number of columns for the first layer set 420 is

$$\frac{{E}_{1 , 1}}{{Q}_{1 , 1}}$$

columns (number of total bits in the first layer set 420, E_{1.1}, the first layer set 420 is divided by the modulation order of the first layer set 420, Q_{1.1}) and the total number of columns for the third layer set 424 is

$$\frac{{E}_{2 , 1}}{{Q}_{2 , 1}}$$

columns (number of total bits in the third layer set 424, E_{2,1}, divided by the modulation order of the third layer set 424, Q_{2.1}). Further, for each RE of the first SB, there are 2 columns of coded bits from the first layer set 420 because the first layer set 420 has 2 layers, and for each RE of the second SB, there are 2 columns of coded bits from the third layer set 424 because the third layer set 424 has 2 layers.

Here, the unavailable entries may be null entries where no information is written to the unavailable entries during the mapping/interleaving process, and no information is read from the unavailable entries during the de-mapping/de-interleaving process. In alternative aspects, the unavailable entries may include control information, beacon signals, error correction information, padding bits, or other types of entries. In certain aspects, the unavailable entries may include entries that include data to be read by the receiver. Other aspects of the entries may be implemented according to various aspects of the present disclosure.

In some aspects of the present disclosure, the unavailable entries exist to achieve rate matching in the third mapping scheme 700. Specifically, in each RE of SB1 in the first mapped block 710, there are 2 columns of coded bits from the first layer set 420 because the first layer set 420 has 2 layers. In each RE of SB2 in the second mapped block 720, there are 2 columns of coded bits from the third layer set 424 because the third layer set 424 has 2 layers. There are 2 rows of coded bits from the first layer set 420 because the first layer set 420 has a modulation order of 2, and 6 rows of coded bits from the third layer set 424 because the third layer set 424 has a modulation order of 6. Consequently, there are 8 (4×2) unavailable entries in each RE of the SB1.

Still referring to FIGS. 4 and 7, in certain aspects of the present disclosure, in the third mapping scheme 700, bits in the second layer set 422 are interleaved with bits in the fourth layer set 426 into a second mapped block 720. The second layer set 424 has a modulation order of 4 (i.e., 4 rows in a RE of SB1) and the fourth layer set 426 has a modulation order of 4 (i.e., 4 rows in a RE of SB2). Since the modulation orders are the same, no unavailable entries are needed for the second mapped block 720. The total number of columns for the second layer set 422 is

$$\frac{{E}_{1 , 2}}{{Q}_{1 , 2}}$$

columns (number of total bits in the second layer set 422, E_{1,2}, divided by the modulation order of the second layer set 422, Q_{1.2}) and the total number of columns for the fourth layer set 426 is

$$\frac{{E}_{2 , 2}}{{Q}_{2 , 2}}$$

columns (number of total bits in the fourth layer set 426, E_{2,2}, divided by the modulation order of the fourth layer set 426, Q_{2.2}). Further, for each RE of the first SB, there are 3 columns of coded bits from the second layer set 422 because the second layer set 422 has 3 layers, and for each RE of the second SB, there is 1 column of coded bits from the fourth layer set 426 because the fourth layer set 426 has 1 layer. As illustrated, the bit interleaving (such as SBPM interleaving) is joint across multiple SBs for a given layer set index (e.g., first layers set of SB1 and first layer set of SB2), but is separate across different layer set indices. For each of the two interleavers, the interleaver may not be strictly rectangular since different layers sets of a given SB may have different modulation order (however, in the illustrated example, the second interleaver is rectangular as the two modulation orders happen to be the same). For each of the two interleavers, the coded bits are written by rows and are read by columns while excluding the unavailable entries.

In some aspects of the present disclosure, in each RE of SB1 in the second mapped block 720, there are 3 columns of coded bits from the second layer set 422 because the second layer set 422 has 3 layers. In each RE of SB2 in the second mapped block 720, there is 1 column of coded bits from the fourth layer set 426 because the fourth layer set 426 has 1 layer. There are 4 rows of coded bits from the second layer set 422 because the second layer set 422 has a modulation order of 4, and 4 rows of coded bits from the fourth layer set 426 because the fourth layer set 426 has a modulation order of 4. Consequently, no rate matching is needed (i.e., no unavailable entries are needed).

In some aspects of the present disclosure, a receiver may receive the mapped blocks above and read the coded bits by de-interleaving each RE of the mapped blocks. The receiver may de-map the mapped blocks 710, 720 by reading the coded bits column by column to reconstruct the first layer set 420, the second layer set 422, the third layer set 424, and the fourth layer set 426, respectively, as described above. In one aspect of the present disclosure, the receiver may de-map the mapped blocks 710, 720, and de-interleave each RE of each of the mapped blocks 710, 720 to extract the coded bits for each of the first layer set 420, the second layer set 422, the third layer set 424, and the fourth layer set 426.

For example, the receiver may de-map the first mapped block 710, and de-interleave each RE of SB1 of the first mapped block 710 to reconstruct the first layer set 420. The receiver may de-map the first mapped block 710, and de-interleave each RE of SB2 of the first mapped block 710 to reconstruct the third layer set 424. The receiver may de-map the second mapped block 720, and de-interleave each RE of SB1 of the second mapped block 720 to reconstruct the second layer set 422. The receiver may de-map the second mapped block 720, and de-interleave each RE of SB2 of the second mapped block 720 to reconstruct the fourth layer set 426.

In FIG. 7, the layer sets are shown as having modulations orders of 2, 4, and 6. However, aspects of the present disclosure include layers sets having different modulation orders. Specifically, certain aspects of the present disclosure include mapping and interleaving layer sets have different modulation orders (e.g., any number between 1-9, 1-21, 1-27, or other numbers and/or ranges of layers). Further, the layer sets are shown as having 1, 2, or 3 layers. However, aspects of the present disclosure include layer sets having different number of layers (e.g., any number between 1-4, 1-16, 1-23, or other numbers and/or ranges of layers).

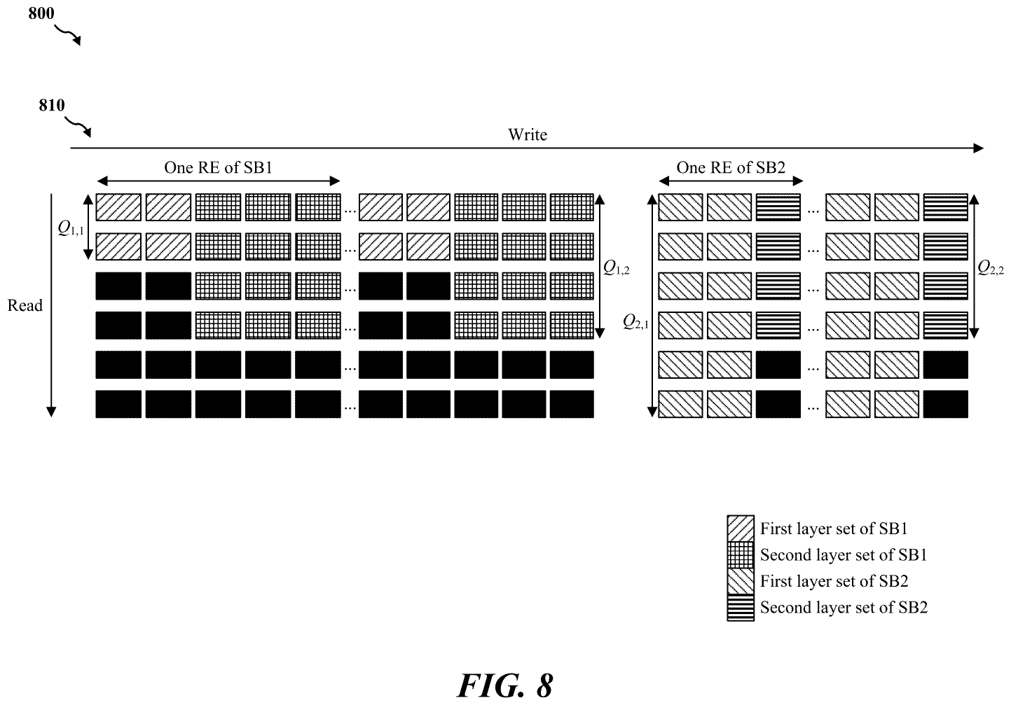

FIG. 8 illustrates an example of a fourth mapping scheme. In FIG. 8, resources with upward diagonal patterns ( [symbol] ) are the first layer set of SB1. Resources with grid patterns ( [symbol] ) are the second layer set of SB1. Resources with downward diagonal patterns ( [symbol] ) are the first layer set of SB2. Resources with horizontal line patterns ( [symbol] ) are the second layer set of SB2. The mapped blocks shown in FIG. 7 are the results of a transmitter performing a mapping and/or interleaving of coded bits in various layers and/or SBs, such as the first and second layers of SB1 and first and second layers of SB2 shown in FIG. 4. Here, the coded bits in the various layers are mapped and/or interleaved into data blocks as described below.

In some aspects of the present disclosure, in a fourth mapping scheme 800, the bits in each layer set are interleaved with bits from other layer sets in the same and different SB(s). Each RE of a mapped block may include coded bits from a layer set interleaved with coded bits from another layer set in the same SB. The notations and/or subscripts are described above. Referring to FIGS. 4 and 8, in the fourth mapping scheme 800, bits in the first layer set 420 are interleaved with bits in the second layer set 422, third layer set 424, and fourth layer set 426 into a mapped block 810. The first layer set 420 has a modulation order of 2 (i.e., 2 rows in a RE of SB1). The second layer set 424 has a modulation order of 4 (i.e., 4 rows in a RE of SB1). The third layer set 424 has a modulation order of 6 (i.e., 6 rows in a RE of SB2). The fourth layer set 426 has a modulation order of 4 (i.e., 4 rows in a RE of SB2). Since the modulation orders are different, unavailable entries are placed into the mapped block 810 to achieve rate matching.

In some aspects, the total number of columns for the first layer set 420 is

$$\frac{{E}_{1 , 1}}{{Q}_{1 , 1}}$$

columns (number of total bits in the first layer set 420, E_{1.1}, divided by the modulation order of the first layer set 420, Q_{1.1}). The total number of columns for the second layer set 422 is

$$\frac{{E}_{1 , 2}}{{Q}_{1 , 2}}$$

columns (number of total bits in the second layer set 422, E_{1,2}, divided by the modulation order of the second layer set 422, Q_{1,2}). The total number of columns for the third layer set 424 is

$$\frac{{E}_{2 , 1}}{{Q}_{2 , 1}}$$

columns (number of total bits in the third layer set 424, E_{2,1}, divided by the modulation order of the third layer set 424, Q_{2.1}). The total number of columns for the fourth layer set 426 is

$$\frac{{E}_{2 , 2}}{{Q}_{2 , 2}}$$

columns (number of total bits in the fourth layer set 426, E_{2,2}, divided by the modulation order of the fourth layer set 426, Q_{2.2}).

In other aspects, for each RE of SB1, there are 2 columns of coded bits from the first layer set 420 because the first layer set 420 has 2 layers, and 3 columns of coded bits from the second layer set 422 because the second layer set 422 has 3 layers. For each RE of SB2, there are 2 columns of coded bits from the third layer set 424 because the third layer set 424 has 2 layers, and 1 column of coded bits from the fourth layer set 426 because the fourth layer set 426 has 1 layer. Since the modulation orders are different, unavailable entries are placed into the mapped block 810 to achieve rate matching. As illustrated, the bit interleaving (such as SBPM interleaving) is joint across multiple layers sets as well as across multiple SBs. Hence, there is only a single interleaver. The interleaver may not be strictly rectangular since different layers sets of different SBs may have different modulation order. For the interleaver, the coded bits are written by rows and are read by columns while excluding the unavailable entries.

Here, the unavailable entries may be null entries where no information is written to the unavailable entries during the mapping/interleaving process, and no information is read from the unavailable entries during the de-mapping/de-interleaving process. In alternative aspects, the unavailable entries may include control information, beacon signals, error correction information, padding bits, or other types of entries. In certain aspects, the unavailable entries may include entries that include data to be read by the receiver. Other aspects of the entries may be implemented according to various aspects of the present disclosure.

In some aspects of the present disclosure, the unavailable entries exist to achieve rate matching in the fourth mapping scheme 800. Specifically, in each RE of SB1 in the mapped block 810, there are 2 columns of coded bits from the first layer set 420 because the first layer set 420 has 2 layers. Further, in each RE of SB1 in the mapped block 810, here are 3 columns of coded bits from the second layer set 422 because the second layer set 422 has 3 layers. There are 2 rows of coded bits from the first layer set 420 because the first layer set 420 has a modulation order of 2, and 4 rows of coded bits from the second layer set 422 because the second layer set 422 has a modulation order of 4

In each RE of SB2 in the mapped block 810, there are 2 columns of coded bits from the third layer set 424 because the third layer set 424 has 2 layer. Further, in each RE of SB2 in the mapped block 810, there is 1 column of coded bits from the fourth layer set 426 because the fourth layer set 426 has 1 layer. There are 6 rows of coded bits from the third layer set 424 because the third layer set 424 has a modulation order of 6, and 4 rows of coded bits from the fourth layer set 426 because the fourth layer set 426 has a modulation order of 4. Consequently, there are 14 (4×2+2×3) unavailable entries in each RE of SB1, and 2 (2×1) unavailable entries in each RE of SB2.

In some aspects of the present disclosure, a receiver may receive the mapped blocks above and read the coded bits by de-interleaving each RE of the mapped blocks. The receiver may de-map the mapped block 810 by reading the coded bits column by column to reconstruct the first layer set 420, the second layer set 422, the third layer set 424, and the fourth layer set 426, respectively, as described above. In one aspect of the present disclosure, the receiver may de-map the mapped block 810, and de-interleave each RE of the mapped block 810 to extract the coded bits for each of the first layer set 420, the second layer set 422, the third layer set 424, and the fourth layer set 426.

For example, the receiver may de-map the mapped block 810, and de-interleave each RE of SB1 of the mapped block 810 to reconstruct the first layer set 420 and the second layer set 422. The receiver may de-map the mapped block 810, and de-interleave each RE of SB2 of the mapped block 810 to reconstruct the third layer set 424 and the fourth layer set 426.

In FIG. 8, the layer sets are shown as having modulations orders of 2, 4, and 6. However, aspects of the present disclosure include layers sets having different modulation orders. Specifically, certain aspects of the present disclosure include mapping and interleaving layer sets have different modulation orders (e.g., any number between 1-5, 1-14, 1-18, or other numbers and/or ranges of layers). Further, the layer sets are shown as having 1, 2, or 3 layers. However, aspects of the present disclosure include layer sets having different number of layers (e.g., any number between 1-15, 1-19, 1-25, or other numbers and/or ranges of layers).

In some aspects of the present disclosure, for a TB mapped to multiple SBs each with one or more sets of spatial layers, the transport block size (TBS) may be determined based on one or more of the following aspects. In a firs aspect, the TBS may be determined based on parameters (e.g., number of REs, modulation order, rank, etc.) of a reference pair of SB/layer set. For example, the following equation may be used, N_{info}=N_{RE,ref}·R·Q_{ref}·V_{ref}, which is quantized to get the TBS. The reference pair of SB/layer set may be selected based on a lowest (or highest) layer set index of the lowest (or highest) SB index, or the pair with the highest (or lowest) number of coded bits N_{RE}·Q·v.

A second aspect to determine the TBS may include determining based on parameters of all layer sets of a reference SB. For example, the following equation may be used,

$${N}_{info} = {N}_{RE , ref} \cdot R \cdot ( {\sum }_{j = 1}^{J} {Q}_{ref , j} \cdot {v}_{ref , j} ) ,$$

which is quantized to get the TBS, where Q_{ref,j} and v_{ref,j} are the modulation order and number of layers of the j′th layer set of the reference SB. The reference SB may be selected based on the lowest (or highest) SB index, or based on the SB with the highest (or lowest) number of coded bits

$${N}_{RE} \cdot {\sum }_{j = 1}^{J} {Q}_{j} \cdot {v}_{j} .$$

A third aspect to determine the TBS may include determining based on parameter of all SBs of a reference layer set. For example, the following equation may be used,

$${N}_{info} = {\sum }_{i = 1}^{I} {N}_{RE , i} \cdot R \cdot {Q}_{i , ref} \cdot {v}_{i , ref} ,$$

which is quantized to get the TBS, where Q_{i,ref} and V_{i,ref} are the modulation order and number of layers of the reference layer set of the i′th SB. The reference layer set may be selected based on the lowest (or highest) layer set index, or may be based on the layer set with the highest (or lowest) number of coded bits across all SBs

$${\sum }_{i = 1}^{I} {N}_{RE , i} \cdot {Q}_{i} \cdot {v}_{i} .$$

A fourth aspect to determine the TBS may include determining based on parameters of all SBs and all layers sets jointly. For example, the following equation may be used,

$${N}_{info} = {\sum }_{i = 1}^{I} {N}_{RE , i} \cdot R \cdot ( {\sum }_{j = 1}^{J} {Q}_{i , j} \cdot {v}_{i , j} ) ,$$

which is quantized to get the TBS, Q_{i,j} and v_{i,j} are the modulation order and number of layers of the j′th reference layer set of the i′th SB.

Certain aspects of the present disclosure may include determining the order of the mapping of coded bits of a CB to the resources scheduled/configured for PDSCH/PUSCH across different SBs and layers sets. In a first aspect, the starting coded bit mapped to a given pair of SB/layer set may be based on the redundancy version (RV) associated with the pair of SB/layer set. The number of RVs may be equal to the number of pairs (for example, if there are two SBs each with two layer sets, the number of RVs is 4). All of the RVs may be indicated to the UE, for example by scheduling DCI. Alternatively, the RV associated with a reference pair of SB/layer set may be signaled to the UE 110, for example by the scheduling DCI and the RVs for the other pairs may be a function of the indicated RV (e.g., based on a fixed RV pattern offset [0,1,2,3] or [0,2,1,3] that is applied to the indicated RV value).

In a second aspect, the staring coded bit mapped to a given SB may based on the RV associated with that SB. The number of RVs may equal to the number of SBs. All RVs may be indicated to the UE 110, for example by the scheduling DCI. Alternatively, the RV associated with a reference SB may be signaled to the UE, for example by the scheduling DCI, and the RV for other SBs may be a function of the indicated RV (e.g., based on a fixed RV pattern offset [0,1,2,3] or [0,2,1,3] that is applied to the indicated RV value).

In a third aspect, the starting coded bit mapped to a given layer set index may be based on the RV associated with that layer set index (e.g., one RV for the first layer set of SB1 and the first layer set of SB2, another RV for the second layer set of SB1 and the second layer set of SB2). The number of RVs may be equal to the number of layer sets, or the maximum number of layer sets in different SBs, if the number of layer sets is not the same in different SBs. All the RVs may be indicated to the UE 110, for example by the scheduling DCI. Alternatively, the RV associated with a reference layer set may be signaled to the UE 110, for example by the scheduling DCI, and the RV for other layer sets may be a function of the indicated RV (e.g., based on a fixed RV pattern offset [0,1,2,3] or [0,2,1,3] that is applied to the indicated RV value).

In a fourth aspect, the starting coded bit mapped to the PDSCH/PUSCH may be based on a single RV, which is indicated to the UE 110, for example by the scheduling DCI.

Aspects of the present disclosure includes configuring UE capability and/or radio resource control (RRC). In one aspect of the present disclosure, the maximum number of SB/layer set pairs that is included in a PDSCH/PUSCH may be reported by the UE 110 through UE capability signaling. In some aspect, the maximum number of SB/layer set pairs may be equivalent to the maximum number of modulation orders corresponding to different pairs of SB/layer set. The maximum number of SB/layer set may be separately reported for DL (PDSCH) versus UL (PUSCH).

In some aspects of the present disclosure, the communication network 100 may configure the UE 110 (using RRC) with the maximum number of layers sets for each SB that belongs to a virtual component carrier. The actual number of layers sets for each SB may dynamically signaled by the scheduling DCI, or implicitly determined based on the number of layers scheduled for that SB as discussed above. The actual number of layer sets may be equal to or smaller than the max number of layer sets.

In one aspect of the present disclosure, the UE 110 may report, via UE capability signaling, whether it supports separate or joint rate matching/bit interleaving across different SBs, and/or across different layers sets. Also, the communication network 100 may configure the UE 110 with RRC to configure the parameters above. This is equivalent to the UE 110 reporting which of the aspect indicated above is supported, or the communication network 100 configuring the UE 110 with one of these modes of operation.

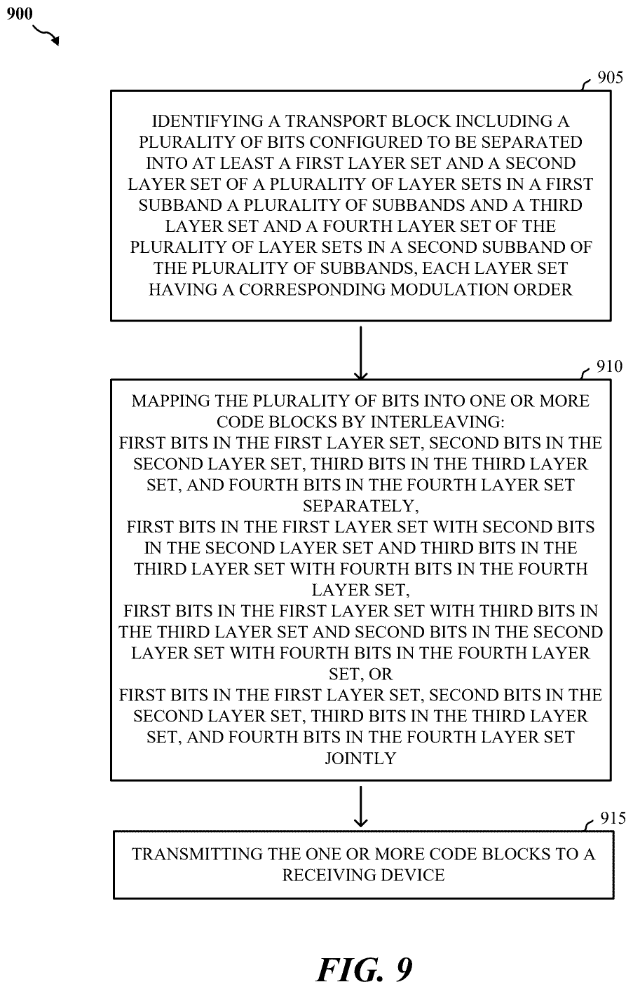

FIG. 9 illustrates an example of a method for mapping bit into a virtual carrier. In some aspects of the present disclosure and referring to FIGS. 4-8, the method may include mapping the coded bits in one or more of the first layer set 420, the second layer set 422, the third layer set 424, and/or the fourth layer set 426 into one or more mapped blocks shown in FIGS. 5-8. In one aspect, the coded bits in one or more of the first layer set 420, the second layer set 422, the third layer set 424, and/or the fourth layer set 426 may be mapped separately as shown in FIG. 5, together with coded bits from layer sets in the same SB as shown in FIG. 6, together with coded bits from layer sets in different SB(s) as shown in FIG. 7, or together with coded bits from layer sets in the same SB and the coded bits in different SB(s) as shown in FIG. 8.

For example, a method 900 may be performed by the one or more of the processor 212, the memory 216, the applications 275, the modem 220, the transceiver 202, the receiver 206, the transmitter 208, the RF front end 288, the communication component 222, the identification component 224, and/or the mapping component 226, and/or one or more other components of the UE 110 in the wireless communication network 100. In another example, the method 900 may be performed by the one or more of the processor 312, the memory 316, the applications 375, the modem 320, the transceiver 302, the receiver 306, the transmitter 308, the RF front end 388, the communication component 322, the identification component 324, and/or the mapping component 326, and/or one or more other components of the BS 105 in the wireless communication network 100.

At block 905, the method 900 may identify a transport block including a plurality of bits configured to be separated into at least a first layer set and a second layer set of a plurality of layer sets in a first subband a plurality of subbands and a third layer set and a fourth layer set of the plurality of layer sets in a second subband of the plurality of subbands, each layer set having a corresponding modulation order. For example, the communication component 222, the identification component 224, the transceiver 202, the receiver 206, the transmitter 208, the RF front end 288, the subcomponents of the RF front end 288, the processor 212, the memory 216, the modem 220, and/or the applications 275 of the UE 110 and/or the communication component 322, the identification component 324, the transceiver 302, the receiver 306, the transmitter 308, the RF front end 388, the subcomponents of the RF front end 388, the processor 312, the memory 316, the modem 320, and/or the applications 375 of the BS 105 may identify a transport block including a plurality of bits configured to be separated into at least a first layer set and a second layer set of a plurality of layer sets in a first subband a plurality of subbands and a third layer set and a fourth layer set of the plurality of layer sets in a second subband of the plurality of subbands, each layer set having a corresponding modulation order as described above.

In certain implementations, the communication component 222, the identification component 224, the transceiver 202, the receiver 206, the transmitter 208, the RF front end 288, the subcomponents of the RF front end 288, the processor 212, the memory 216, the modem 220, and/or the applications 275 of the UE 110 and/or the communication component 322, the identification component 324, the transceiver 302, the receiver 306, the transmitter 308, the RF front end 388, the subcomponents of the RF front end 388, the processor 312, the memory 316, the modem 320, and/or the applications 375 of the BS 105 may be configured to and/or may define means for identifying a transport block including a plurality of bits configured to be separated into at least a first layer set and a second layer set of a plurality of layer sets in a first subband a plurality of subbands and a third layer set and a fourth layer set of the plurality of layer sets in a second subband of the plurality of subbands, each layer set having a corresponding modulation order.

At block 910, the method 900 may map the plurality of bits into one or more code blocks by interleaving first bits in the first layer set, second bits in the second layer set, third bits in the third layer set, and fourth bits in the fourth layer set separately as described in the scheme of FIG. 5. The method 900 may map the plurality of bits into one or more coded blocks by interleaving first bits in the first layer set with second bits in the second layer set and third bits in the third layer set with fourth bits in the fourth layer set as described in the scheme of FIG. 6. The method 900 may map the plurality of bits into one or more coded blocks by interleaving first bits in the first layer set with third bits in the third layer set and second bits in the second layer set with fourth bits in the fourth layer set as described in the scheme of FIG. 7. The method 900 may map the plurality of bits into one or more coded blocks by interleaving first bits in the first layer set, second bits in the second layer set, third bits in the third layer set, and fourth bits in the fourth layer set jointly as described in the scheme of FIG. 8.

For example, the communication component 222, the mapping component 226, the transceiver 202, the receiver 206, the transmitter 208, the RF front end 288, the subcomponents of the RF front end 288, the processor 212, the memory 216, the modem 220, and/or the applications 275 of the UE 110 and/or the communication component 322, the mapping component 326, the transceiver 302, the receiver 306, the transmitter 308, the RF front end 388, the subcomponents of the RF front end 388, the processor 312, the memory 316, the modem 320, and/or the applications 375 of the BS 105 of the UE 110 may map the plurality of bits into one or more code blocks by interleaving first bits in the first layer set, second bits in the second layer set, third bits in the third layer set, and fourth bits in the fourth layer set separately, first bits in the first layer set with second bits in the second layer set and third bits in the third layer set with fourth bits in the fourth layer set, first bits in the first layer set with third bits in the third layer set and second bits in the second layer set with fourth bits in the fourth layer set, or first bits in the first layer set, second bits in the second layer set, third bits in the third layer set, and fourth bits in the fourth layer set jointly as described above.

In certain implementations, the communication component 222, the mapping component 226, the transceiver 202, the receiver 206, the transmitter 208, the RF front end 288, the subcomponents of the RF front end 288, the processor 212, the memory 216, the modem 220, and/or the applications 275 of the UE 110 and/or the communication component 322, the mapping component 326, the transceiver 302, the receiver 306, the transmitter 308, the RF front end 388, the subcomponents of the RF front end 388, the processor 312, the memory 316, the modem 320, and/or the applications 375 of the BS 105 may be configured to and/or may define means for mapping the plurality of bits into one or more code blocks by interleaving first bits in the first layer set, second bits in the second layer set, third bits in the third layer set, and fourth bits in the fourth layer set separately, first bits in the first layer set with second bits in the second layer set and third bits in the third layer set with fourth bits in the fourth layer set, first bits in the first layer set with third bits in the third layer set and second bits in the second layer set with fourth bits in the fourth layer set, or first bits in the first layer set, second bits in the second layer set, third bits in the third layer set, and fourth bits in the fourth layer set jointly.

At block 915, the method 900 may transmit the one or more code blocks to a receiving device. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 and/or the communication component 322, the transceiver 302, the receiver 306, the transmitter 308, the RF front end 388, the subcomponents of the RF front end 388, the processor 312, the memory 316, the modem 320, and/or the applications 375 of the BS 105 of the UE 110 may transmit the one or more code blocks to a receiving device.

In one aspect, the communication component 222 may send the digital signals to the transceiver 202 or the transmitter 208. The transceiver 202 or the transmitter 208 may convert the digital signals to electrical signals and send to the RF front end 288. The RF front end 288 may filter and/or amplify the electrical signals. The RF front end 288 may send the electrical signals as electro-magnetic signals via the one or more antennas 265.

In certain implementations, the communication component 222, the transceiver 202, the receiver 206, the transmitter 208, the RF front end 288, the subcomponents of the RF front end 288, the processor 212, the memory 216, the modem 220, and/or the applications 275 of the UE 110 and/or the communication component 322, the transceiver 302, the receiver 306, the transmitter 308, the RF front end 388, the subcomponents of the RF front end 388, the processor 312, the memory 316, the modem 320, and/or the applications 375 of the BS 105 may be configured to and/or may define means for transmitting the one or more code blocks to a receiving device.

Alternatively or additionally, the method 900 may further include the method above, wherein, for mapping the plurality of bits by interleaving the first bits in the first layer set and second bits in the second layer set in the first subband, the first layer set includes a first modulation order and the second layer set includes a second modulation order identical to the first modulation order.

Alternatively or additionally, the method 900 may further include any of the methods above, wherein, for mapping the plurality of bits by interleaving the first bits in the first layer set in the first subband and the third bits in the third layer set in the second subband, the first layer set includes a first modulation order and the third layer set includes a third modulation order different than the first modulation order.

Alternatively or additionally, the method 900 may further include any of the methods above, further comprising identifying a transport block size of the transport block is based on one of parameters of a reference layer set of a plurality of layer sets of a reference subband of the plurality of subbands, parameters of one or more layer sets of a reference subband of the plurality of subbands, parameters of each reference layer set of the plurality of subbands, or parameters of each plurality of layer sets of the plurality of subbands.

Alternatively or additionally, the method 900 may further include any of the methods above, further comprising identifying an order of mapping the plurality of bits to resources for receiving the one or more code blocks by identifying a starting code bit of a corresponding layer set of a corresponding subband based on a redundancy version (RV) of the corresponding layer set and the corresponding subband, a starting code bit of a plurality of layer sets of a corresponding subband based on a RV of the corresponding subband, a starting code bit of a corresponding layer set of the plurality of subbands based on a RV of the corresponding layer set, or a starting code bit of the plurality of layer sets of the plurality subband based on a single RV.

In the first identification method above, the starting code bit of a layer set is identified based on the RV of the layer set and the SB. As such, there is one RV associated with each pair of layer set/SB.

In a second identification method above, the starting code bit of a SB may be identified based on the RV of all the layer sets in the SB. As such, there is one RV associated with each SB and the number of RVs equal to the number of SBs.

In a third identification method above, the starting code bit of a layer set may be identified based on the RV associated with the corresponding layer set. As such, there is one RV for each layer set within a SB, and the number of RVs equal to the number of layer sets.

Alternatively or additionally, the method 900 may further include any of the methods above, further comprising transmitting downlink control information (DCI) one or more RVs.

Alternatively or additionally, the method 900 may further include any of the methods above, further comprising receiving, from the receiving device, a signal indicating one or more of a maximum number of subbands or a maximum number of layer sets of the receiving device, wherein the receiving device is a user equipment. This may be related to the maximum number of modulation orders of different SB/layer set pairs. The receiving device may transmit the information to indicate the receiver capability relating to the maximum number of modulation orders it supports. Based on this information, the transmitting device may limit the number of SBs and/or layers according to the maximum number indicated by the receiving device.

Alternatively or additionally, the method 900 may further include any of the methods above, wherein the signal indicates a first maximum number of subbands and a first maximum number of layer sets for uplink and a second maximum number of subbands and a second maximum number of layer sets for downlink.

Alternatively or additionally, the method 900 may further include any of the methods above, further comprising transmitting, from the transmitting device, a signal indicating a maximum number of layer sets for each subband in a virtual component carrier of the transmitting device, wherein the transmitting device is a base station. The maximum number of layer sets for each subband may be transmitted by the transmitting device based on the available resources for each component carrier of the virtual channel. The available resources may be determined based on network congestion, availability of resources of the network, bandwidth resources of other cells, etc.

Alternatively or additionally, the method 900 may further include any of the methods above, wherein transmitting the signal comprises transmitting the signal through downlink control information (DCI) or a radio resource configuration (RRC).

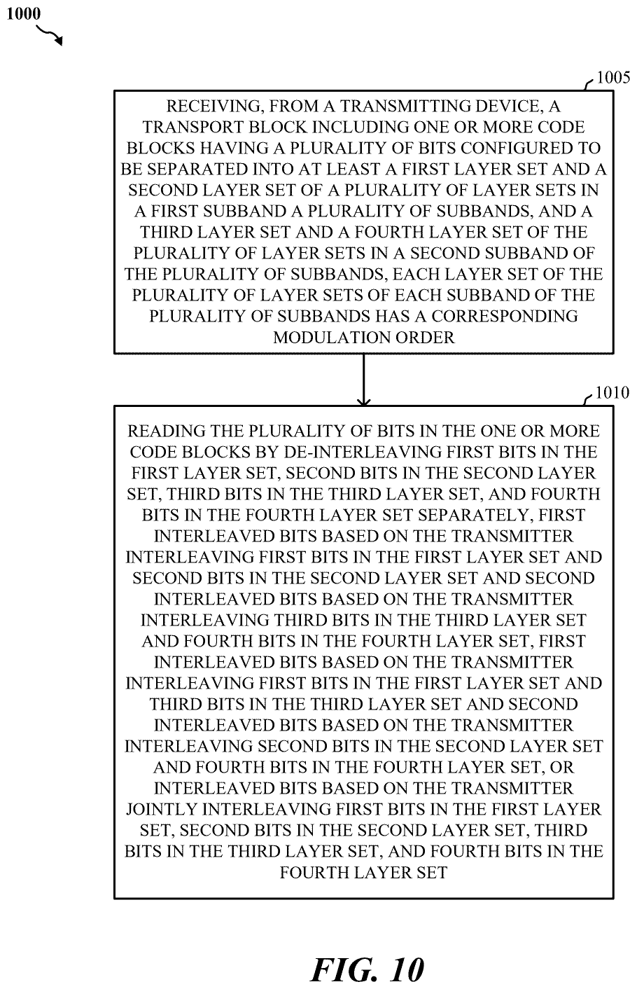

FIG. 10 illustrates an example of a method for receiving mapped bits. In some aspects of the present disclosure and referring to FIGS. 4-8, the method may include de-mapping and/or de-interleaving the one or more mapped blocks to retrieve the data in the first layer set 420, the second layer set 422, the third layer set 424, and/or the fourth layer set 426 as shown in FIGS. 5-8. In one aspect, the receiving device may retrieve the mapped bits by de-mapping the mapped blocks, and de-interleave a mapped block into a single layer set as described in FIG. 5, 2 or more layer sets in a single SB as described in FIG. 6, 2 or more layer sets in two or more SBs as described in FIG. 7, or two or more layer sets in the same SB and a layer set in different SB(s) as described in FIG. 8.

For example, a method 1000 may be performed by the one or more of the processor 212, the memory 216, the applications 275, the modem 220, the transceiver 202, the receiver 206, the transmitter 208, the RF front end 288, the communication component 222, the identification component 224, and/or the mapping component 226, and/or one or more other components of the UE 110 in the wireless communication network 100. In another example, the method 900 may be performed by the one or more of the processor 312, the memory 316, the applications 375, the modem 320, the transceiver 302, the receiver 306, the transmitter 308, the RF front end 388, the communication component 322, the identification component 324, and/or the mapping component 326, and/or one or more other components of the BS 105 in the wireless communication network 100.

At block 1005, the method 1000 may receive, from a transmitting device, a transport block including one or more code blocks having a plurality of bits configured to be separated into at least a first layer set and a second layer set of a plurality of layer sets in a first subband a plurality of subbands, and a third layer set and a fourth layer set of the plurality of layer sets in a second subband of the plurality of subbands, each layer set of the plurality of layer sets of each subband of the plurality of subbands has a corresponding modulation order. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 and/or the communication component 322, the transceiver 302, the receiver 306, the transmitter 308, the RF front end 388, the subcomponents of the RF front end 388, the processor 312, the memory 316, the modem 320, and/or the applications 375 of the BS 105 may receive, from a transmitting device, a transport block including one or more code blocks having a plurality of bits configured to be separated into at least a first layer set and a second layer set of a plurality of layer sets in a first subband a plurality of subbands, and a third layer set and a fourth layer set of the plurality of layer sets in a second subband of the plurality of subbands, each layer set of the plurality of layer sets of each subband of the plurality of subbands has a corresponding modulation order as described above.

In certain implementations, the communication component 222, the transceiver 202, the receiver 206, the transmitter 208, the RF front end 288, the subcomponents of the RF front end 288, the processor 212, the memory 216, the modem 220, and/or the applications 275 of the UE 110 and/or the communication component 322, the transceiver 302, the receiver 306, the transmitter 308, the RF front end 388, the subcomponents of the RF front end 388, the processor 312, the memory 316, the modem 320, and/or the applications 375 of the BS 105 may be configured to and/or may define means for receiving, from a transmitting device, a transport block including one or more code blocks having a plurality of bits configured to be separated into at least a first layer set and a second layer set of a plurality of layer sets in a first subband a plurality of subbands, and a third layer set and a fourth layer set of the plurality of layer sets in a second subband of the plurality of subbands, each layer set of the plurality of layer sets of each subband of the plurality of subbands has a corresponding modulation order.

At block 1010, the method 1000 may read the plurality of bits in the one or more code blocks by de-interleaving first bits in the first layer set, second bits in the second layer set, third bits in the third layer set, and fourth bits in the fourth layer set separately as described in the scheme of FIG. 5. The method 1000 may read the plurality of bits by de-interleaving first interleaved bits based on the transmitter interleaving first bits in the first layer set and second bits in the second layer set and second interleaved bits based on the transmitter interleaving third bits in the third layer set and fourth bits in the fourth layer set as described in the scheme of FIG. 6. The method 1000 may read the plurality of bits by de-interleaving first interleaved bits based on the transmitter interleaving first bits in the first layer set and third bits in the third layer set and second interleaved bits based on the transmitter interleaving second bits in the second layer set and fourth bits in the fourth layer set as described in the scheme of FIG. 7. The method 1000 may read the plurality of bits by de-interleaving interleaved bits based on the transmitter jointly interleaving first bits in the first layer set, second bits in the second layer set, third bits in the third layer set, and fourth bits in the fourth layer set as described in the scheme of FIG. 8. For example, the identification component 224, the processor 212, the memory 216, the modem 220, and/or the applications 275 of the UE 110 and/or the communication component 322, the identification component 324, the processor 312, the memory 316, the modem 320, and/or the applications 375 of the BS 105 may read the plurality of bits in the one or more code blocks by de-interleaving first bits in the first layer set, second bits in the second layer set, third bits in the third layer set, and fourth bits in the fourth layer set separately, first interleaved bits based on the transmitter interleaving first bits in the first layer set and second bits in the second layer set and second interleaved bits based on the transmitter interleaving third bits in the third layer set and fourth bits in the fourth layer set, first interleaved bits based on the transmitter interleaving first bits in the first layer set and third bits in the third layer set and second interleaved bits based on the transmitter interleaving second bits in the second layer set and fourth bits in the fourth layer set, or interleaved bits based on the transmitter jointly interleaving first bits in the first layer set, second bits in the second layer set, third bits in the third layer set, and fourth bits in the fourth layer set as described above.

In certain implementations, the identification component 224, the processor 212, the memory 216, the modem 220, and/or the applications 275 of the UE 110 and/or the communication component 322, the identification component 324, the processor 312, the memory 316, the modem 320, and/or the applications 375 of the BS 105 may be configured to and/or may define means for reading the plurality of bits in the one or more code blocks by de-interleaving first bits in the first layer set, second bits in the second layer set, third bits in the third layer set, and fourth bits in the fourth layer set separately, first interleaved bits based on the transmitter interleaving first bits in the first layer set and second bits in the second layer set and second interleaved bits based on the transmitter interleaving third bits in the third layer set and fourth bits in the fourth layer set, first interleaved bits based on the transmitter interleaving first bits in the first layer set and third bits in the third layer set and second interleaved bits based on the transmitter interleaving second bits in the second layer set and fourth bits in the fourth layer set, or interleaved bits based on the transmitter jointly interleaving first bits in the first layer set, second bits in the second layer set, third bits in the third layer set, and fourth bits in the fourth layer set.

Alternatively or additionally, the method 1000 may further include the method above, wherein, for reading the plurality of bits by de-interleaving the first bits in the first layer set and second bits in the second layer set in the first subband, the first layer set includes a first modulation order and the second layer set includes a second modulation order identical to the first modulation order.

Alternatively or additionally, the method 1000 may further include any of the methods above, wherein, for reading the plurality of bits by de-interleaving the first bits in the first layer set in the first subband and the third bits in the third layer set in the second subband, the first layer set includes a first modulation order and the third layer includes a third modulation order different than the first modulation order.

Alternatively or additionally, the method 1000 may further include any of the methods above, wherein a transport block size of the transport block is based on one of: one or more parameters of a reference layer set of a plurality of layer sets of a reference subband of the plurality of subbands, one or more parameters of one or more layer sets of a reference subband of the plurality of subbands, one or more parameters of each reference layer set of the plurality of subbands, or one or more parameters of each plurality of layer sets of the plurality of subbands.

Alternatively or additionally, the method 1000 may further include any of the methods above, further comprising identifying an order of mapping the plurality of bits to resources for receiving the one or more code blocks by identifying a starting code bit of a corresponding layer set of a corresponding subband based on a redundancy version (RV) of the corresponding layer set and the corresponding subband, a starting code bit of a plurality of layer sets of a corresponding subband based on a RV of the corresponding subband, a starting code bit of a corresponding layer set of the plurality of subbands based on a RV of the corresponding layer set, or a starting code bit of the plurality of layer sets of the plurality subband based on a single RV.

Alternatively or additionally, the method 1000 may further include any of the methods above, further comprising receiving downlink control information (DCI) indicating one or more RVs.

Alternatively or additionally, the method 1000 may further include any of the methods above, further comprising transmitting, to the transmitting device, a signal indicating one or more of a maximum number of subbands or a maximum number of layer sets of the receiving device, wherein the receiving device is a user equipment.

Alternatively or additionally, the method 1000 may further include any of the methods above, wherein the signal indicates a first maximum number of subbands and a first maximum number of layer sets for uplink and a second maximum number of subbands and a second maximum number of layer sets for downlink.

Alternatively or additionally, the method 1000 may further include any of the methods above, further comprising receiving, from the transmitting device, a signal indicating a maximum number of layer sets for each subband in a virtual component carrier of the transmitting device, wherein the transmitting device is a base station.

Alternatively or additionally, the method 1000 may further include any of the methods above, wherein receiving the signal comprises receiving the signal through downlink control information (DCI) or a radio resource configuration (RRC).

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of wireless communication by a receiving device, comprising:
receiving, from a transmitting device, a transport block including one or more code blocks having a plurality of bits configured to be separated into at least a first layer set and a second layer set of a plurality of layer sets in a first subband a plurality of subbands, and a third layer set and a fourth layer set of the plurality of layer sets in a second subband of the plurality of subbands, each layer set of the plurality of layer sets of each subband of the plurality of subbands has a corresponding modulation order; and
reading the plurality of bits in the one or more code blocks by de-interleaving:
first bits in the first layer set, second bits in the second layer set, third bits in the third layer set, and fourth bits in the fourth layer set separately,
first interleaved bits based on the transmitter interleaving first bits in the first layer set and second bits in the second layer set and second interleaved bits based on the transmitter interleaving third bits in the third layer set and fourth bits in the fourth layer set,
first interleaved bits based on the transmitter interleaving first bits in the first layer set and third bits in the third layer set and second interleaved bits based on the transmitter interleaving second bits in the second layer set and fourth bits in the fourth layer set, or
interleaved bits based on the transmitter jointly interleaving first bits in the first layer set, second bits in the second layer set, third bits in the third layer set, and fourth bits in the fourth layer set.

2. The method of claim 1, wherein, for reading the plurality of bits by de-interleaving the first bits in the first layer set and second bits in the second layer set in the first subband, the first layer set includes a first modulation order and the second layer set includes a second modulation order identical to the first modulation order.

3. The method of claim 1, wherein, for reading the plurality of bits by de-interleaving the first bits in the first layer set in the first subband and the third bits in the third layer set in the second subband, the first layer set includes a first modulation order and the third layer includes a third modulation order different than the first modulation order.

4. The method of claim 1, wherein a transport block size of the transport block is based on one of:
one or more parameters of a reference layer set of a plurality of layer sets of a reference subband of the plurality of subbands,
one or more parameters of one or more layer sets of a reference subband of the plurality of subbands,
one or more parameters of each reference layer set of the plurality of subbands, or
one or more parameters of each plurality of layer sets of the plurality of subbands.

5. The method of claim 1, further comprising identifying an order of mapping the plurality of bits to resources for receiving the one or more code blocks by identifying:
a starting code bit of a corresponding layer set of a corresponding subband based on a redundancy version (RV) of the corresponding layer set and the corresponding subband,
a starting code bit of a plurality of layer sets of a corresponding subband based on a RV of the corresponding subband,
a starting code bit of a corresponding layer set of the plurality of subbands based on a RV of the corresponding layer set, or
a starting code bit of the plurality of layer sets of the plurality subband based on a single RV.

6. The method of claim 1, further comprising transmitting, to the transmitting device, a signal indicating one or more of a maximum number of subbands or a maximum number of layer sets of the receiving device, wherein the receiving device is a user equipment.

7. The method of claim 6, wherein the signal indicates a first maximum number of subbands and a first maximum number of layer sets for uplink and a second maximum number of subbands and a second maximum number of layer sets for downlink.

8. The method of claim 1, further comprising receiving, from the transmitting device, a signal indicating a maximum number of layer sets for each subband in a virtual component carrier of the transmitting device, wherein the transmitting device is a base station.

9. A receiving device, comprising:
one or more transceivers;
one or more memories including instructions; and
one or more processors communicatively coupled with the one or more transceivers and the one or more memories, the one or more processors are configured to execute the instructions to:
receive, from a transmitting device, a transport block including one or more code blocks having a plurality of bits configured to be separated into at least a first layer set and a second layer set of a plurality of layer sets in a first subband a plurality of subbands, and a third layer set and a fourth layer set of the plurality of layer sets in a second subband of the plurality of subbands, each layer set of the plurality of layer sets of each subband of the plurality of subbands has a corresponding modulation order; and
read the plurality of bits in the one or more code blocks by de-interleaving:
first bits in the first layer set, second bits in the second layer set, third bits in the third layer set, and fourth bits in the fourth layer set separately,
first interleaved bits based on the transmitter interleaving first bits in the first layer set and second bits in the second layer set and second interleaved bits based on the transmitter interleaving third bits in the third layer set and fourth bits in the fourth layer set,
first interleaved bits based on the transmitter interleaving first bits in the first layer set and third bits in the third layer set and second interleaved bits based on the transmitter interleaving second bits in the second layer set and fourth bits in the fourth layer set, or
interleaved bits based on the transmitter jointly interleaving first bits in the first layer set, second bits in the second layer set, third bits in the third layer set, and fourth bits in the fourth layer set.

10. The receiving device of claim 9, wherein, to read the plurality of bits by de-interleaving the first bits in the first layer set and second bits in the second layer set in the first subband, the first layer set includes a first modulation order and the second layer set includes a second modulation order identical to the first modulation order.

11. The receiving device of claim 9, wherein, to read the plurality of bits by de-interleaving the first bits in the first layer set in the first subband and the third bits in the third layer set in the second subband, the first layer set includes a first modulation order and the third layer includes a third modulation order different than the first modulation order.

12. The receiving device of claim 9, wherein a transport block size of the transport block is based on one of:
parameters of a reference layer set of a plurality of layer sets of a reference subband of the plurality of subbands,
parameters of one or more layer sets of a reference subband of the plurality of subbands,
parameters of each reference layer set of the plurality of subbands, or
parameters of each plurality of layer sets of the plurality of subbands.

13. The receiving device of claim 9, wherein the one or more processors are further configured to identify an order of mapping the plurality of bits to resources for receiving the one or more code blocks by identifying:
a starting code bit of a corresponding layer set of a corresponding subband based on a redundancy version (RV) of the corresponding layer set and the corresponding subband,
a starting code bit of a plurality of layer sets of a corresponding subband based on a RV of the corresponding subband,
a starting code bit of a corresponding layer set of the plurality of subbands based on a RV of the corresponding layer set, or
a starting code bit of the plurality of layer sets of the plurality subband based on a single RV.

14. The receiving device of claim 9, wherein the one or more processors are further configured to transmit, to the transmitting device, a signal indicating one or more of a maximum number of subbands or a maximum number of layer sets of the receiving device, wherein the receiving device is a user equipment.

15. The receiving device of claim 14, wherein the signal indicates a first maximum number of subbands and a first maximum number of layer sets for uplink and a second maximum number of subbands and a second maximum number of layer sets for downlink.

16. The receiving device of claim 9, wherein the one or more processors are further configured to receive, from the transmitting device, a signal indicating a maximum number of layer sets for each subband in a virtual component carrier of the transmitting device, wherein the transmitting device is a base station.

17. A receiving device, comprising:
means for receiving, from a transmitting device, a transport block including one or more code blocks having a plurality of bits configured to be separated into at least a first layer set and a second layer set of a plurality of layer sets in a first subband a plurality of subbands, and a third layer set and a fourth layer set of the plurality of layer sets in a second subband of the plurality of subbands, each layer set of the plurality of layer sets of each subband of the plurality of subbands has a corresponding modulation order; and
means for reading the plurality of bits in the one or more code blocks by de-interleaving:
first bits in the first layer set, second bits in the second layer set, third bits in the third layer set, and fourth bits in the fourth layer set separately,
first interleaved bits based on the transmitter interleaving first bits in the first layer set and second bits in the second layer set and second interleaved bits based on the transmitter interleaving third bits in the third layer set and fourth bits in the fourth layer set,
first interleaved bits based on the transmitter interleaving first bits in the first layer set and third bits in the third layer set and second interleaved bits based on the transmitter interleaving second bits in the second layer set and fourth bits in the fourth layer set, or
interleaved bits based on the transmitter jointly interleaving first bits in the first layer set, second bits in the second layer set, third bits in the third layer set, and fourth bits in the fourth layer set.

18. The receiving device of claim 17, wherein, for means for reading the plurality of bits by de-interleaving the first bits in the first layer set and second bits in the second layer set in the first subband, the first layer set includes a first modulation order and the second layer set includes a second modulation order identical to the first modulation order.

19. The receiving device of claim 17, wherein, for means for reading the plurality of bits by de-interleaving the first bits in the first layer set in the first subband and the third bits in the third layer set in the second subband, the first layer set includes a first modulation order and the third layer includes a third modulation order different than the first modulation order.

20. The receiving device of claim 17, wherein a transport block size of the transport block is based on one of:
one or more parameters of a reference layer set of a plurality of layer sets of a reference subband of the plurality of subbands,
one or more parameters of one or more layer sets of a reference subband of the plurality of subbands,
one or more parameters of each reference layer set of the plurality of subbands, or
one or more parameters of each plurality of layer sets of the plurality of subbands.
